(19) United States
(12) Patent Application Publication
(10) Pub. No.: US 2016/0004438 A1
(43) Pub. Date: Jan. 7, 2016

(54) STORAGE DEVICE INCLUDING NONVOLATILE MEMORY AND MEMORY CONTROLLER, AND OPERATING METHOD OF STORAGE DEVICE

(71) Applicant: SAMSUNG ELECTRONICS CO., LTD., SUWON-SI (KR)

(72) Inventors: SANGKWON MOON, OSAN-RI (KR); MOONSANG KWON, SEOUL (KR); KYUNG HO KIM, SEOUL (KR); MOONWOOK OH, SEOUL (KR)

(21) Appl. No.: 14/790,342

(22) Filed: Jul. 2, 2015

(30) Foreign Application Priority Data
Jul. 2, 2014 (KR) 10-2014-0082549

(51) Int. Cl. G06F 3/06

(52) U.S. Cl. CPC G06F 3/061; G06F 3/0659; G06F 3/0631; G06F 3/0679

(57) ABSTRACT

An operation method of a storage device includes receiving quality of service (QoS) information of a plurality of virtual channels and storing the QoS information. A nonvolatile memory is accessed using different schemes according to the stored QoS information and commands received by virtual channels. The virtual channels are channels through which the storage device communicates with an external device.

### CROSS-REFERENCE TO RELATED APPLICATIONS

This U.S. non-provisional patent application claims priority under 35 U.S.C. §119 of Korean Patent Application No. 10-2014-0082549, filed on Jul. 2, 2014, the entire contents of which are hereby incorporated by reference.

### BACKGROUND OF THE RELATED ART

The application relates to semiconductor memories, and more particularly, to a storage device including a nonvolatile memory and a memory controller, and an operating method of the storage device.

A storage device stores data under the control of a host device such as a computer, a smart phone, a smart pad, etc. A storage device includes a device storing data in a magnetic disk such as a hard disk drive (HDD) and a device storing data in a semiconductor memory, in particular, a nonvolatile memory such as a solid state drive (SSD), a memory card, etc.

A nonvolatile memory includes a ROM (read only memory), a PROM (programmable ROM), an EPROM (electrically programmable read-only memory), an EEPROM (electrically erasable programmable read-only memory), a flash memory, a PRAM (phase change RAM), an MRAM (magnetic random access memory), an RRAM (resistive RAM), an FeRAM (ferroelectric RAM), etc.

As a semiconductor manufacturing technology develops, an operation speed of a host device such as a computer, a smart phone, a smart pad, etc. that communicates with a storage device is being improved. As an operation speed of a host device is improved, virtualization that one host device drives a variety of virtual machines is being introduced. Virtual machines being driven in a host device share a storage device of the host device. Since a conventional storage device is designed without considering a virtualization environment, it cannot be effectively used in a virtualization environment. Thus, a study of a new storage device that can support a virtualization environment is urgently required.

### SUMMARY

Embodiments of the application provide an operation method of a storage device including a nonvolatile memory and a memory controller configured to control the nonvolatile memory. The operation method may include receiving quality of service (QoS) information of a plurality of virtual channels; storing the QoS information; and accessing the nonvolatile memory using different schemes according to the stored QoS information and commands being received from the virtual channels. The plurality of virtual channels are channels through which the storage device communicates with an external device.

In an embodiment, the memory controller comprises a plurality of register sets corresponding to the plurality of virtual channels respectively. The memory controller is configured to communicate with the external device through one input/output channel. Each register set forms one virtual channel together with one input/output channel.

In another embodiment, the accessing the nonvolatile memory using different schemes comprises: distinguishing which virtual channel, among the plurality of virtual channels, the command is received through depending on which register set, among the register sets, the command is received through; selecting an access scheme according to the distinguished virtual channel and QoS corresponding to the distinguished virtual channel, the QoS being obtained from the QoS information; and accessing the nonvolatile memory according to the selected access scheme.

In yet another embodiment, addresses of the nonvolatile memory are divided to be assigned to the plurality of virtual channels respectively. The accessing the nonvolatile memory using different schemes comprises: distinguishing which virtual channel, among the virtual channels, the command is received through according to an address being received from the external device together with a command, the address corresponding to one of the plurality of virtual channels; selecting an access scheme according to the distinguished virtual channel and a QoS corresponding to the distinguished virtual channel, the QoS being obtained from the QoS information; and accessing the nonvolatile memory according to the selected access scheme.

In still another embodiment, the accessing the nonvolatile memory using different schemes comprises: performing a write operation of a first scheme with respect to the nonvolatile memory according to a first write command from a first virtual channel where a first QoS is required; and performing a write operation of a second scheme with respect to the nonvolatile memory according to a second write command from a second virtual channel where a second QoS lower than the first QoS is required.

In another embodiment, a write speed of the first scheme is faster than a write speed of the second scheme.

In yet another embodiment, a degree that the nonvolatile memory is deteriorated according to the write operation of the second scheme is smaller than a degree that the nonvolatile memory is deteriorated according to the write operation of the first scheme.

In still another embodiment, the storage device further comprises a buffer memory configured to store data to be written in the nonvolatile memory and data being read from the nonvolatile memory. The accessing the nonvolatile memory using different schemes comprises: dividing a storage space of the buffer memory to assign the divided storage spaces to the plurality virtual channels respectively according to the QoS information; and accessing the nonvolatile memory according to the commands using the storage spaces assigned to the plurality virtual channels respectively.

In another embodiment, the memory controller is configured to manage a command queue configured to store the commands. The accessing the nonvolatile memory using different schemes comprises dividing slots of the command queue to generate a plurality of virtual command queues corresponding to the virtual channels respectively. Queue depths of the plurality of virtual command queues are controlled according to the QoS information.

In yet another embodiment, the memory controller is configured to manage a command queue configured to store the commands. The accessing the nonvolatile memory using different schemes comprises dividing slots of the command queue to generate a plurality of virtual command queues corresponding to the virtual channels respectively. The frequency that each of the command queues is selected and thereby a command is performed is controlled according to the QoS information.

In still another embodiment, the memory controller is configured to manage a command queue configured to store the commands. The accessing the nonvolatile memory using different schemes comprises: enqueuing the commands in the command queue; and scheduling the commands enqueued in the command queue according to the QoS information.

In another embodiment, the maximum delay time that the commands enqueued in the command queue are delayed by the scheduling is differently set according to the QoS information.

In yet another embodiment, the memory controller is configured to manage a command queue configured to store the commands. The accessing the nonvolatile memory using different schemes comprises: selecting activation channels among the channels according to the QoS information; and accessing the nonvolatile memory using the selected activation channels.

In still another embodiment, the memory controller is configured to manage a command queue configured to store the commands. The accessing the nonvolatile memory using different schemes comprises: selecting a first command from the command queue; and performing the first command according to a second QoS in the case that the second QoS of a second command subsequent to the first command is higher than a first QoS of the first command, and performing the first command according to the first QoS in the case that the second QoS is not higher than the first QoS.

Embodiments of the application also provide a storage device. The storage device may include a nonvolatile memory; and a memory controller configured to include an input/output channel configured to communicate with an external device and a plurality of register sets forming a plurality of virtual channels respectively together with the input/output channel and control the nonvolatile memory. The memory controller is configured to receive quality of service (QoS) information of the virtual channels from the external device and access the nonvolatile memory in different ways according to commands being received through the virtual channels and the QoS information.

Embodiments of the application provide a method of accessing a nonvolatile memory executed by a memory controller. The method includes receiving quality of service (QoS) information and a command corresponding to each of a plurality of virtual machines. A resource for supporting each virtual machine is allocated in accordance with the corresponding QoS information. Each of the virtual machines accesses the nonvolatile memory according to the corresponding command and using the allocated resource.

In an embodiment, the allocated resource is a speed that data is written to the nonvolatile memory.

In an embodiment, the allocated resource is a scheduling priority for accessing the nonvolatile memory.

In an embodiment, the allocated resource is random access memory assigned to the virtual machine.

In an embodiment, the allocated resource is one or more communication channels between the memory controller and the nonvolatile memory.

In an embodiment, the allocated resource is a frequency with which commands for accessing the nonvolatile memory are executed by the memory controller.

In an embodiment, the allocated resource is queue space for storing commands corresponding to the virtual machine and the commands identify operations for accessing the nonvolatile memory.

In an embodiment, a virtual machine to which the received QoS and corresponding command apply is identified by: an identifier of the virtual machine within the command, an address within the command that corresponds to the virtual machine, or a register corresponding to the virtual machine that receives the command from a host device.

In an embodiment, the method further includes receiving multiple items of QoS information and receiving multiple commands, each of which corresponds to one of the virtual machines and to a different one of the multiple items of QoS information. The resource for supporting the one virtual machine is allocated in accordance with the most superior QoS information within the multiple items of QoS information.

### BRIEF DESCRIPTION OF THE FIGURES

Preferred embodiments of the application will be described below in more detail with reference to the accompanying drawings. The embodiments of the application may, however, be embodied in different forms and should not be constructed as limited to the embodiments set forth herein. Rather, these embodiments are provided so that this disclosure will be thorough and complete, and will fully convey the scope of the application to those skilled in the art. Like numbers refer to like elements throughout.

FIG. 1 is a block diagram illustrating a virtualization system in accordance with an embodiment of the application.

FIG. 2 is a block diagram illustrating a storage device in accordance with a first embodiment of the application.

FIG. 3 is a flow chart illustrating an operation method of a storage device in accordance with an embodiment of the application.

FIG. 4 illustrates examples of QoS information related to a plurality of virtual channels.

FIG. 5 illustrates examples in which a storage device identifies an accessed virtual channel among a plurality of virtual channels.

FIG. 6 is a flow chart illustrating an example of differently accessing a nonvolatile memory according to a QoS.

FIG. 7 illustrates an example of write operations having different speeds.

FIG. 8 is a table illustrating characteristics of first through fourth write operations.

FIG. 9 illustrates another example of differently accessing a nonvolatile memory according to a QoS.

FIG. 10 illustrates still another example of differently accessing a nonvolatile memory according to a QoS.

FIG. 11 is a block diagram illustrating a storage device in accordance with a second embodiment of the application.

FIG. 12 illustrates yet another example of differently accessing a nonvolatile memory according to a QoS.

FIG. 13 illustrates still yet another example of differently accessing a nonvolatile memory according to a QoS.

FIG. 14 is a block diagram illustrating a memory controller in accordance with an embodiment of the application.

FIG. 15 is a block diagram illustrating a nonvolatile memory in accordance with an embodiment of the application.

FIG. 16 is a circuit illustrating a memory block in accordance with an embodiment of the application.

FIG. 17 is a circuit illustrating a memory block in accordance with another embodiment of the application.

FIG. 18 is a block diagram illustrating a storage device in accordance with a third embodiment of the application.

FIG. 19 is a block diagram illustrating a memory controller in accordance with another embodiment of the application.

FIG. 20 is a block diagram illustrating a computing device in accordance with an embodiment of the application.

### DETAILED DESCRIPTION OF PREFERRED EMBODIMENTS

Embodiments of the application will be described more fully hereinafter with reference to the accompanying drawings, in which embodiments of the application are shown. The technology may, however, be embodied in many different forms and should not be construed as limited to the embodiments set forth herein. Rather, these embodiments are provided so that this disclosure will be thorough and complete, and will fully convey the scope of the application to those skilled in the art. In the drawings, the size and relative sizes of layers and regions may be exaggerated for clarity. Like numbers refer to like elements throughout.

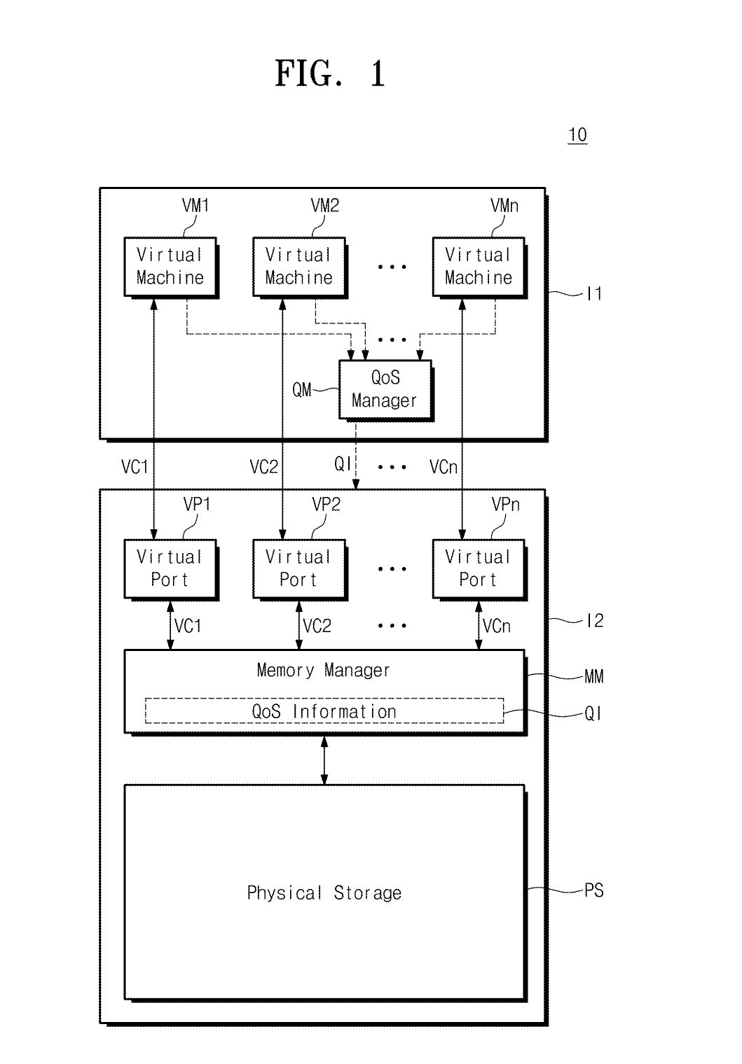

FIG. 1 is a block diagram illustrating a virtualization system in accordance with an embodiment of the application. Referring to FIG. 1, a virtualization system 10 includes a host layer 11 and a storage layer 12.

The host layer 11 is configured to drive a plurality of virtual machines VM1˜VMn. For example, the host layer 11 may be a virtual host hierarchy. The virtual machines VM1˜VMn may communicate with the storage layer 12 through a plurality of virtual channels VC1˜VCn. Each of the virtual machines VM1˜VMn may independently drive an operating system and an application.

A quality of service QoS manager QM may manage QoS information QI. The QoS information QI may include information about a QoS (for example, a minimum QoS) which each of the virtual machines VM1˜VMn or each of the virtual channels VC1˜VCn requires. For example, the QoS may be a data communication speed with respect to the storage layer 12.

The QoS manager QM may collect the QoS information QI from the virtual machines VM1˜VMn. The QoS manager QM may transmit the collected QoS information QI to the storage layer 12.

The QoS manager QM may transmit the QoS information QI to the storage layer 12 through one of the virtual channels VC1˜VCn. The QoS manager QM may transmit the QoS information of each virtual channel to the storage layer 12 through a corresponding virtual channel. The QoS manager QM may transmit the QoS information QI to the storage layer 12 through a separate channel configured to transmit the QoS information QI.

The QoS manager QM may be software being driven in a main machine among the virtual machines VM1˜VMn of the host layer 11. In the case that a virtual machine monitor VMM is provided to the host layer 11, the QoS manager QM may be software being driven independently of the virtual machine monitor VMM. The QoS manager QM may be software being driven on the virtual machine monitor VMM.

The virtual machines VM1˜VMn may be configured to communicate with the storage layer 12 through the QoS manager QM. The virtual machines VM1˜VMn may access the storage layer 12 through the QoS manager QM. The QoS manager QM may transmit signals being transmitted from the virtual machines VM1˜VMn to the storage layer 12 and transmit signals being transmitted from the storage layer 12 to the virtual machines VM1˜VMn.

The storage layer 12 is configured to support the virtual channels VC1˜VCn through a plurality of virtual ports VP1˜VPn. The virtual ports VP1˜VPn may communicate with the host layer 11 through the virtual channels VC1˜VCn. The virtual ports VP1˜VPn may configured to communicate with a memory manager MM through the virtual channels VC1˜VCn.

The memory manager MM may manage the virtual ports VP1˜VPn. The memory manager MM may access a physical storage PS of the storage layer 12 using information being received from the host layer 11 through the virtual channels VC1˜VCn and the virtual ports VP1˜VPn. The memory manager MM may transmit information being read from the physical storage PS or information being generated internally to the host layer 11 through the virtual channels VC1˜VCn and the virtual ports VP1˜VPn.

The memory manager MM may receive the QoS information QI from the host layer 11 to store it. The memory manager MM may access the physical storage PS using different schemes using the stored QoS information QI. For example, when a read or write request is received through a specific virtual channel among virtual channels VC1˜VCn, the memory manager MM may identify a QoS of the specific virtual channel with reference to the stored QoS information QI. In the case that the QoS (that is, a QoS being required in the specific virtual channel) of the specific virtual channel is relatively low, the memory manager MM may access the physical storage PS using a relatively slow read or write scheme. In the case that the QoS of the specific virtual channel is relatively high, the memory manager MM may access the physical storage PS using a relatively fast read or write method.

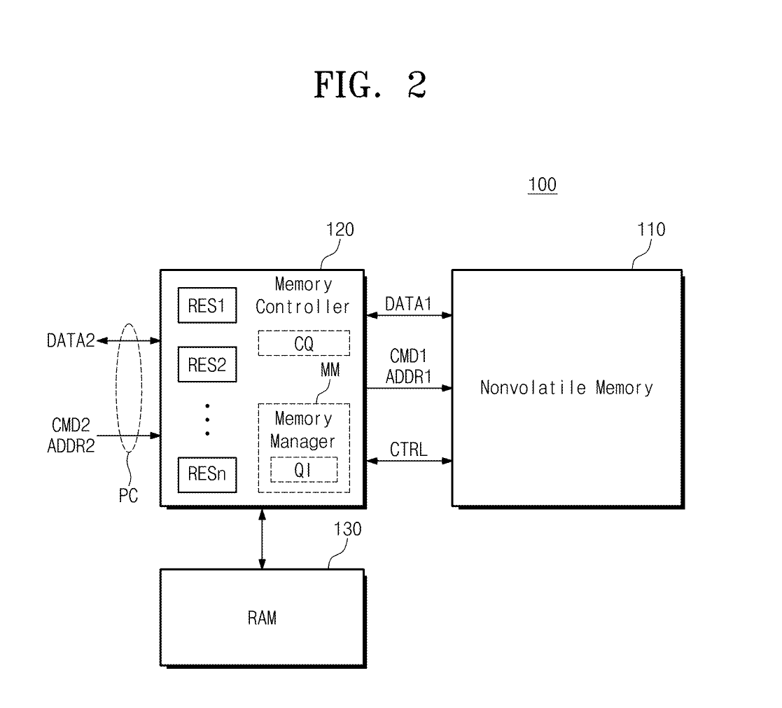

FIG. 2 is a block diagram illustrating a storage device in accordance with a first embodiment of the application. A storage device 100 may be configured to implement the storage layer 12 of FIG. 1.

Referring to FIGS. 1 and 2, the storage device 100 includes a nonvolatile memory 110, a memory controller 120 and a RAM 130.

The nonvolatile memory 110 may perform write, read and erase operations under the control of the memory controller 120. The nonvolatile memory 110 may exchange first DATA1 data with the memory controller 120. For example, the nonvolatile memory 110 may receive the first data DATA1 from the memory controller 120 and write the first data DATA1. The nonvolatile memory 110 may perform a read operation and output the read data as the first data DATA1 to the memory controller 120. The nonvolatile memory 110 may correspond to the physical storage PS of the storage layer 12.

The nonvolatile memory 110 may receive a first command CMD1 and a first address ADDR1 from the memory controller 120. The nonvolatile memory 110 may exchange control signal CTRL with the memory controller 120. For example, the nonvolatile memory 110 may receive at least one of a chip selection signal (/CE) selecting at least one semiconductor chip among a plurality of semiconductor chips constituting the nonvolatile memory 110, a command latch enable signal CLE indicating that a signal being received from the memory controller 120 is the first command CMD1, an address latch enable signal ALE indicating that a signal being received from the memory controller 120 is the first address ADDR1, a read enable signal (/RE) which is generated by the memory controller 120 in a read operation and is periodically toggled to be used to adjust timing, a write enable signal (/WE) being activated by the memory controller 120 when the first command CMD1 or the first address ADDR1 is transmitted, a write protect signal (/WP) being activated by the memory controller 120 to prevent an unintended write or erase when a power supply is changed, and a data strobe signal DQS which is generated by the memory controller 120 in a write operation and is periodically toggled to be used to adjust an input sync of the first data DATA1. For example, the nonvolatile memory 110 may output at least one of a ready & busy signal (R/nB) indicating that the nonvolatile memory 110 performs a program, erase or read operation and a data strobe signal DQS which is generated from the read enable signal (/RE) by the nonvolatile memory 110 and is periodically toggled to be used to adjust an output sync of the first data DATA1 to the memory controller 120.

The nonvolatile memory 110 may include a flash memory. However, the nonvolatile memory 110 is not limited to include a flash memory. The nonvolatile memory 110 may include at least one of various nonvolatile memories such as a PRAM (phase-change RAM), an MRAM (magnetic RAM), an RRAM (resistive RAM), an FeRAM (ferroelectric RAM), etc.

The memory controller 120 is configured to control the nonvolatile memory 110. For example, the memory controller 120 may control the nonvolatile memory 110 to perform a write, read or erase operation. The memory controller 120 may exchange the first data DATA1 and the control signal CTRL with the nonvolatile memory 110 and output the first command CMD1 and the first address ADDR1 to the nonvolatile memory 110.

The memory controller 120 may control the nonvolatile memory 110 under a control of an external host device (for example, an external host device implementing the host layer 11). The memory controller 120 may exchange second data DATA2 with the host device and receive a second command CMD2 and a second address ADDR2 from the host device. For example, the memory controller 120 may communicate the second data DATA2, the second command CMD2 and the second address ADDR2 with the host device through one physical channel PC.

The memory controller 120 may communicate the first data DATA1 with the nonvolatile memory 110 by a first unit and communicate the second data DATA2 with the host device by a second unit different from the first unit.

The memory controller 120 may communicate the first data DATA1 with the nonvolatile memory 110 and transmit the first command CMD1 and the first address ADDR1 to the nonvolatile memory 110 according to a first format. The memory controller 120 may exchange the second data DATA2 with the host device and receive the second command CMD2 and the second address ADDR2 from the host device according to a second format different from the first format.

The memory controller 120 includes a plurality of register sets RES1˜RESn. The register sets RES1˜RESn may be identified to different storage devices (e.g., different virtual channels VC1˜VCn) respectively by the host layer 11. Each of the register sets RES1˜RESn may include a plurality of registers being used to access the storage device 100. Each of the register sets RES1˜RESn may include a control register, a command register, a state register, etc. For example, the register sets RES1˜RESn may have the same structure.

Since the register sets RES1˜RESn are identified to separate virtual channels VC1˜VCn by the host layer 11, the register sets RES1˜RESn may form the virtual channels VC1˜VCn, connecting the host layer 11 and the storage layer 12, together with the single physical channel PC. The virtual channels VC1˜VCn may share the single physical channel PC. That is, the virtual channels VC1˜VCn may be virtualized by the register sets RES1˜RESn on the single physical channel PC.

The first register set RES1 may form the first virtual channel VC1 (or the first virtual port VP1) together with the physical channel PC. The memory controller 120 may process the second data DATA2, the second command CMD1 and the second address ADDR2 being communicated through the physical channel PC in association with the first register set RES1 as being communicated through the first virtual channel VC1. The kth register set RESk (k is an integer between 1 and n) may form the kth virtual channel VCk (or the kth virtual port VPk) together with the physical channel PC. The memory controller 120 may process the second data DATA2, the second command CMD1 and the second address ADDR2 being communicated through the physical channel PC in association with the kth register RESk as being communicated through the kth virtual channel VCk.

The memory controller 120 may drive the memory manager MM. The memory controller 120 may manage the virtual channels VC1˜VCn through the memory manager MM. The memory controller 120 may store QoS information QI and access the nonvolatile memory 110 according to the QoS information QI.

The memory controller 120 may include a command queue CQ. The memory controller 120 may manage the second command CMD2 being received through the virtual channels VC1˜VCn using the command queue CQ. For example, the memory controller 120 may enqueue the second command CMD2 being received through the virtual channels VC1˜VCn or the first command CMD1 being generated from the second command CMD2 to the command queue CQ. The memory controller 120 may perform a scheduling controlling an execution order of commands enqueued in the command queue CQ. The memory controller 120 may access the nonvolatile memory 110 according to a command set to be performed first in the command queue CQ. The memory controller 120 may access the nonvolatile memory 110 according to the QoS information QI.

The memory controller 120 may use the RAM 130 as a buffer memory, a cache memory, or an operation memory. For example, the memory controller 120 may receive the second data DATA2 from the host device, store the received second data DATA2 in the RAM 130 and write the second data DATA2 stored in the RAM 130 in the nonvolatile memory 110 as the first data DATA1. The memory controller 120 may read the first data DATA1 from the nonvolatile memory 110, store the received first data DATA1 in the RAM 130 and output the first data DATA1 stored in the RAM 130 to the host device as the second data DATA2. The memory controller 120 may store data read from the nonvolatile memory 110 in the RAM 130 and write the data stored in the RAM 130 in the nonvolatile memory 110 again.

The memory controller 120 may store data or code needed to manage the nonvolatile memory 110 in the RAM 130. For example, the memory controller 120 may read data or code needed to manage the nonvolatile memory 110 from the nonvolatile memory 110 and may load and drive the read data or code.

The memory controller 120 may access the RAM 130 according to the QoS information QI.

The RAM 130 may include at least one of various random access memories such as a DRAM (dynamic RAM), an SRAM (static RAM), an SDRAM (synchronous DRAM), a PRAM (phase-change RAM), an MRAM (magnetic RAM), an RRAM (resistive RAM), an FeRAM (ferroelectric RAM), etc.

The storage device 100 may perform a write, read or erase of data. The storage device 100 may include a solid state drive (SSD) or a hard disk drive (HDD). The storage device 100 may include memory cards such as a personal computer memory card international association (PCMCIA) card, a compact flash (CF) card, a smart media card (SM, SMC), a memory stick, a multimedia card (MMC, RS-MMC, MMCmicro), an SD card (SD, miniSD, microSD, SDHC), a universal flash memory device (UFS), etc. The storage device 100 may include a mounted-type memory such as an eMMC (embedded multimedia card), a UFS, a PPN (perfect page new), etc.

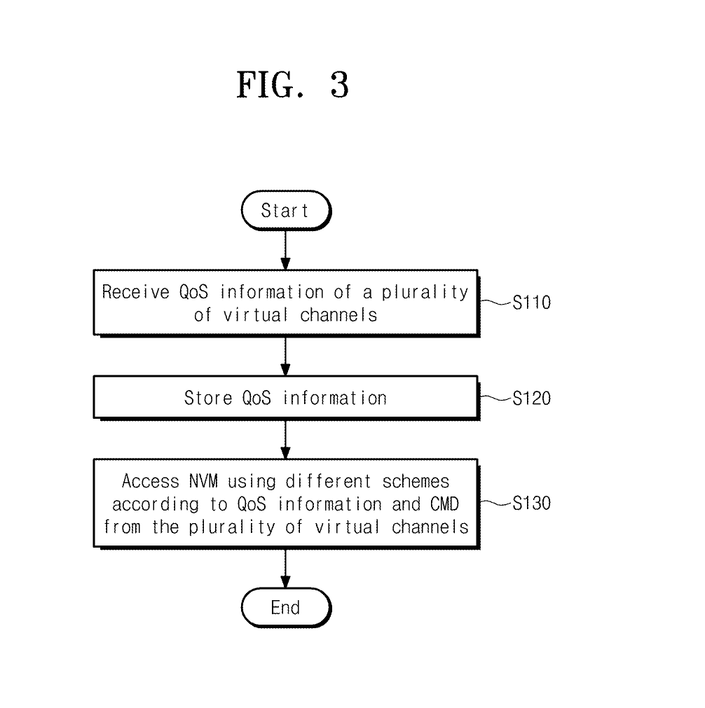

FIG. 3 is a flow chart illustrating an operation method of a storage device in accordance with an embodiment of the application. Referring to FIGS. 1 through 3, in a step S110, the storage device 100 may receive QoS information QI of virtual channels VC1˜VCn from an external host device driving the host layer 11. The QoS information QI may include information about a QoS being required from each of the virtual channels VC1˜VCn.

In a step S120, the storage device 100 stores the received QoS information QI. For example, the storage device 100 may store the received QoS information QI in an internal memory (e.g., a RAM 130 or an internal memory of a memory controller 120).

In a step S130, the storage device 100 may access the nonvolatile memory 110 using different schemes according to the QoS information QI and a second command CMD2 being received through the virtual channels VC1˜VCn. For example, the storage device 100 may distinguish which virtual channel among the virtual channels VC1˜VCn the second command CMD2 corresponds to. If a virtual channel related to the second command CMD2 is distinguished, the storage device 100 may check a QoS of the distinguished virtual channel with reference to the QoS information QI. The storage device 100 may enqueue the second command CMD2, or the first command CMD1 being generated from the second command CMD2 in the command queue CQ to schedule the second command CMD2, or the first command CMD1. The storage device 100 may select a command registered in the command queue CQ and access the nonvolatile memory 110 according to the selected command and a QoS related to the selected command.

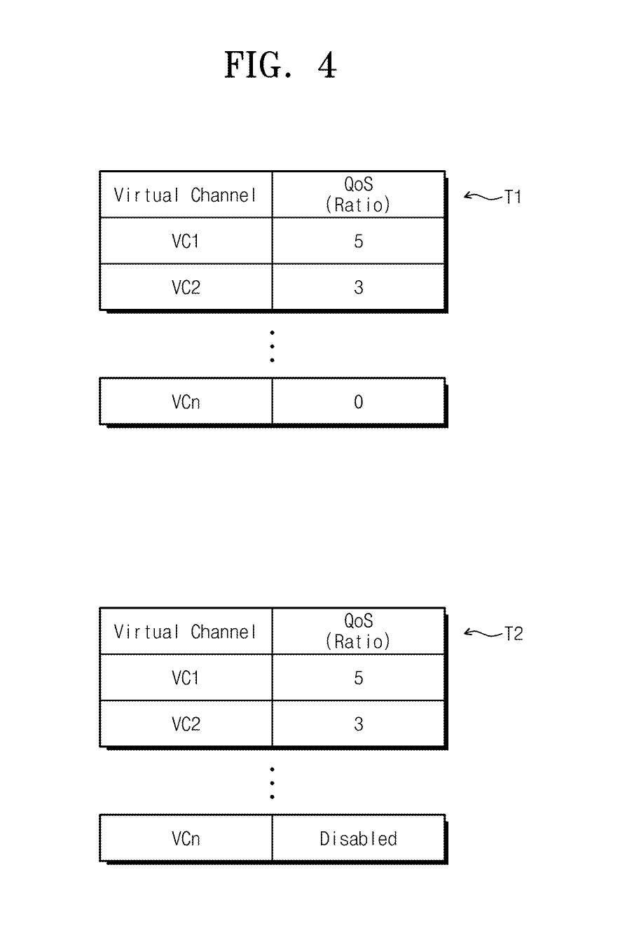

FIG. 4 illustrates examples of QoS information QI related to a plurality of virtual channels VC1˜VCn. Referring to FIGS. 1 and 2 and a first table T1 of FIG. 4, a QoS of ‘5’ may be assigned to the first virtual channel VC1, a QoS of ‘3’ may be assigned to the second virtual channel VC2 and a QoS of ‘0’ may be assigned to the nth virtual channel VCn. QoSs assigned to the virtual channels VC1˜VCn may indicate relative ratios.

The nth virtual channel VCn to which a QoS of ‘0’ is assigned may be a virtual channel that is not used. For example, if first through nth register sets RES1˜RESn are provided to the storage device 100, the storage device 100 supports n number of virtual channels VC1˜VCn. However, in the case that m number of virtual machines (m is a positive integer smaller than n) are driven in the host layer 11, n-m number of virtual channels are not used. A QoS of ‘0’ may be assigned to the virtual channels that are not used.

Referring to FIGS. 1 and 2 and a second table T2 of FIG. 4, a virtual channel that is not used may be disabled. If a virtual channel is disabled, among the register sets RES1˜RESn, register sets corresponding to the disabled virtual channel are disabled and thereby power may not be supplied. Peripheral circuits related to the disabled register sets may also be disabled and thereby power may not be supplied.

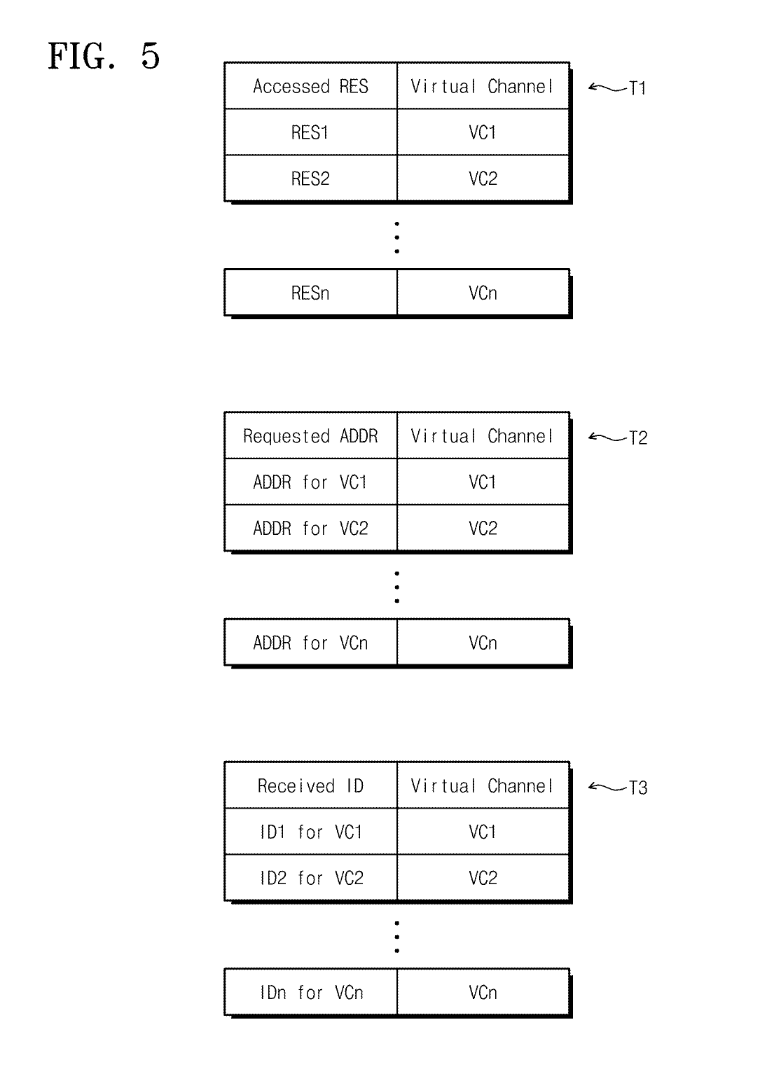

FIG. 5 illustrates examples in which a storage device identifies an accessed virtual channel among a plurality of virtual channels. Referring to FIGS. 1 and 2 and a first table T1 of FIG. 5, a virtual channel is identified according to a register set being accessed among a plurality of register sets RES1˜RESn. For example, if the second data DATA2, the second command CMD2 and the second address ADDR2 are communicated in relation with the first register set RES1, the storage device 100 may identify that a communication is performed through the first virtual channel VC1. If the second data DATA2, the second command CMD2 and the second address ADDR2 are communicated in connection with the kth register set (k is an integer between 1 and n), the storage device 100 may identify that a communication is performed through the kth virtual channel VCk.

Referring to FIGS. 1 and 2 and a second table T2 of FIG. 5, the storage device 100 may identify a virtual channel according to the second address ADDR2. For example, the host layer 11 may assign an address range of the nonvolatile memory 110 to each of the virtual machines VM1˜VMn.

A storage space of the nonvolatile memory 110 may be assigned to each of the virtual machines VM1˜VMn. Each of the virtual machines VM1˜VMn may be set to access the storage device 100 within an address (e.g., logical address) range of the assigned storage space.

The host layer 11 may transmit information about the address ranges assigned to the virtual machines VM1˜VMn, that is, the virtual channels VC1˜VCn to the storage device 100 together with QoS information QI. A QoS manager QM may transmit information about the address range to the storage device 100 as a part of the QoS information QI. The storage device 100 may store the information about the address ranges together with the QoS information QI or as a part of the QoS information QI.

The storage device 100 may identify a virtual channel through which the second command CMD2 and the second data DATA2 related to the second address ADDR2 are communicated according to a value of the second address ADDR2 being received from an external host device driving the host layer 11.

Referring to FIGS. 1 and 2 and a third table T3 of FIG. 5, the storage device 100 may identify a virtual channel according to an identifier being communicated through the virtual channels VC1˜VCn.

For example, the host layer 11 may assign identifiers ID1˜IDn to the virtual machines VM1˜VMn respectively. When a specific virtual machine communicates with the storage device 100, the host layer 11 may transmit an identifier ID of the specific virtual machine to the storage device 100. The storage device 100 may identify a virtual channel according to the identifier ID.

The identifiers ID1˜IDn may be transmitted as a part of the second data DATA2, the second address ADDR2 or the second command CMD2. The identifiers ID1˜IDn may be transmitted as independent information from the second data DATA2, the second address ADDR2 and the second command CMD2.

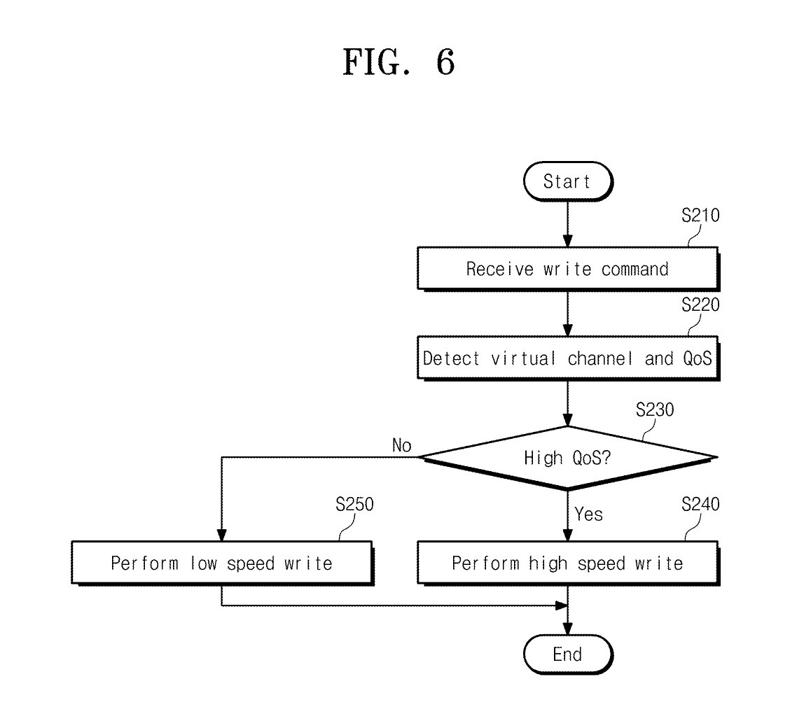

FIG. 6 is a flow chart illustrating an example of differently accessing a nonvolatile memory according to a QoS. Referring to FIGS. 1, 2 and 6, in a step S210, the storage device 100 receives a write command.

In a step S220, the storage device 100 identifies a virtual channel and a QoS related to the received write command. For example, the storage device 100 may detect a virtual channel related to the write command according to one of the methods described with reference to FIG. 5. The storage device 100 may detect the QoS corresponding to the identified virtual channel with reference to QoS information QI.

In step S230, the storage device 100 may distinguish whether the QoS corresponding to the write command is high or low. If the QoS corresponding to the write command is high (e.g., higher than a reference QoS value), in a step S240, the storage device 100 may perform a high speed write operation. If the service quality corresponding to the write command is low (e.g., lower than the reference QoS value), in a step S250, the storage device 100 may perform a low speed write operation.

As described with reference to FIG. 4, a service quality of a virtual channel may be set not by two stages of high and low QoSs but by a plurality of stages. In this case, the storage device 100 may select one of write operations having different speeds from one another to perform the selected one.

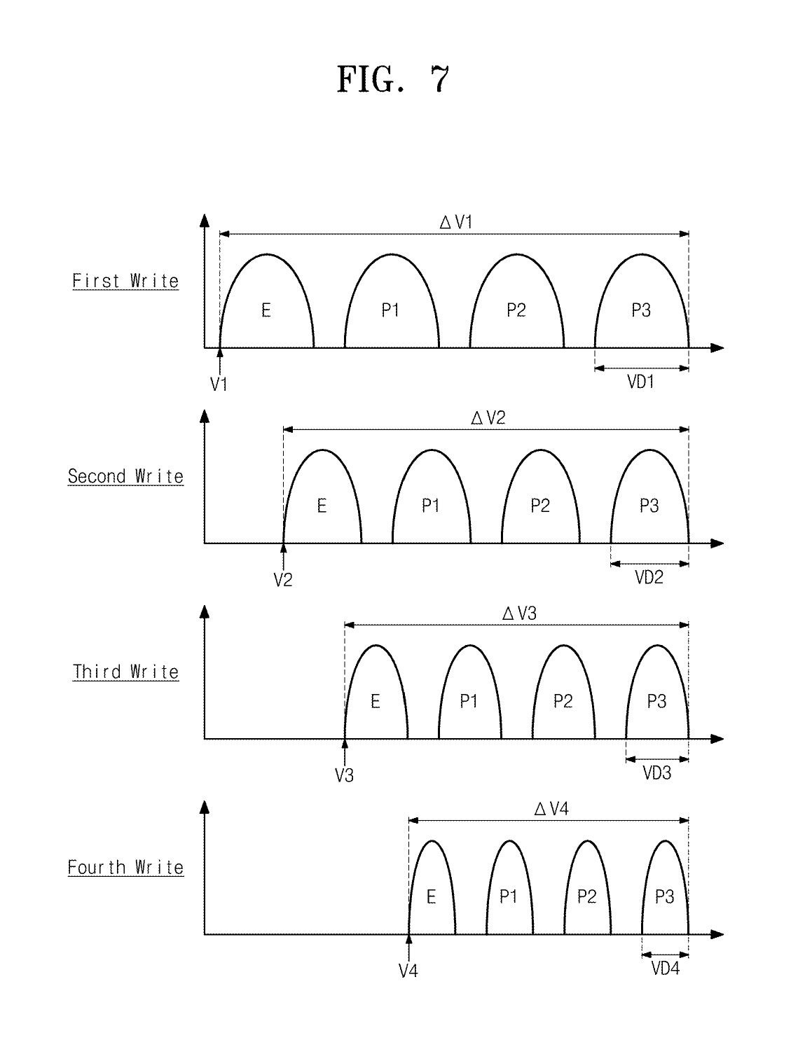

FIG. 7 illustrates an example of writes having different speeds. In FIG. 7, a horizontal axis represents a threshold voltage of memory cells of the nonvolatile memory 110 and a vertical axis represents the number of memory cells. That is, in FIG. 7, a threshold voltage distribution of memory cells corresponding to writes operations having different speeds from one another respectively is illustrated.

If a first write operation is performed, memory cells may have an erase state E and first through third program states P1˜P3. Threshold voltages of memory cells in the erase state E may be higher than a first voltage V1. In the first write operation, the memory cells in the erase state E may be neglected without being programmed. A distribution width (for example, an average distribution width) of threshold voltages of the memory cells corresponding to the erase state E or the program states P1˜P3 respectively may be a first distribution width VD1. If the first write operation is performed, the maximum difference among the threshold voltages of the memory cells may be a first voltage difference ΔV1.

If a second write operation is performed, memory cells may have an erase state E and first through third program states P1˜P3. Threshold voltages of memory cells in the erase state E may be higher than a second voltage V2. In the second write operation, the memory cells in the erase state E may be programmed to have threshold voltages higher than the second voltage V2. A distribution width (for example, an average distribution width) of threshold voltages of the memory cells corresponding to the erase state E or the program states P1˜P3 respectively may be a second distribution width VD2. If the second write operation is performed, the maximum difference among the threshold voltages of the memory cells may be a second voltage difference ΔV2.

The second distribution width VD2 may be smaller than the first distribution width VD1. The second write operation is more elaborately performed compared with the first write operation. For example, in a write operation of memory cells, a program voltage may be applied to gates of the memory cells. A write operation of the memory cells may be performed by an ISPP (incremental step pulse program) that gradually increases a program voltage level. A distribution width of threshold voltages of the memory cells may be determined by the increment of the program voltage. For example, the more the increment of the program voltage is reduced, the more elaborately the write operation is performed and a distribution width of threshold voltages of the memory cells is reduced. For example, if the increment of the program voltage is reduced, the time being consumed when performing a write operation increases.

Since the second distribution width VD2 is smaller than the first distribution width VD1, the increment of the program voltage of the second write operation is smaller than the increment of the program voltage of the first write operation. Thus, the time being consumed when performing the second write operation is longer than the time being consumed when performing the first write operation. That is, the first write operation may be a high speed write operation compared with the second write operation.

A difference (e.g., the maximum difference) between threshold voltages of the memory cells may be proportional to a stress (or deterioration) which the memory cells experience. The greater a difference (e.g., the maximum difference) between threshold voltages of the memory cells is, the more a stress (or deterioration) the memory cells experience. The second voltage difference ΔV2 is smaller than the first voltage difference ΔV1. Thus, a stress (or deterioration) which the memory cells experience in the second write operation is smaller than a stress (or deterioration) which the memory cells experience in the first write operation. Furthermore, the memory cells written by the second write operation may experience smaller stress than that by the first write operation when other memory cells are written.

If a third write operation is performed, memory cells may have an erase state E and first through third program states P1˜P3. Threshold voltages of memory cells in the erase state E may be higher than a third voltage V3. In the third write operation, the memory cells in the erase state E may be programmed to have a threshold voltage higher than the third voltage V3. A distribution width (for example, an average distribution width) of threshold voltages of the memory cells corresponding to the erase state E or the program states P1˜P3 respectively may be a third distribution width VD3. If the third write operation is performed, the maximum difference among the threshold voltages of the memory cells may be a third voltage difference ΔV3.

Since the third distribution width VD3 is smaller than the second distribution width VD2, the time being consumed when performing the third write operation is longer than the time being consumed when performing the second write operation. That is, the second write operation may be a high speed write operation compared with the third write operation. A stress (or deterioration) which the memory cells experience in the third write operation is smaller than a stress (or deterioration) which the memory cells experience in the second write operation. Furthermore, the memory cells written by the third write operation may experience smaller stress than that by the second write operation when other memory cells are written.

If a fourth write operation is performed, memory cells may have an erase state E and first through third program states P1˜P3. Threshold voltages of memory cells in the erase state E may be higher than a fourth voltage V4. In the fourth write operation, the memory cells in the erase state E may be programmed to have a threshold voltage higher than the fourth voltage V4. A distribution width (for example, an average distribution width) of threshold voltages of the memory cells corresponding to the erase state E or the program states P1˜P3 respectively may be a fourth distribution width VD4. If the fourth write operation is performed, the maximum difference among the threshold voltages of the memory cells may be a fourth voltage difference ΔV4.

Since the fourth distribution width VD4 is smaller than the third distribution width VD3, the time being consumed when performing the fourth write operation is longer than the time being consumed when performing the third write operation. That is, the third write operation may be a high speed write operation compared with the fourth write operation. A stress (or deterioration) which the memory cells experience in the fourth write operation is smaller than a stress (or deterioration) which the memory cells experience in the third write operation. Furthermore, the memory cells written by the fourth write operation may experience smaller stress than that by the third write operation when other memory cells are written.

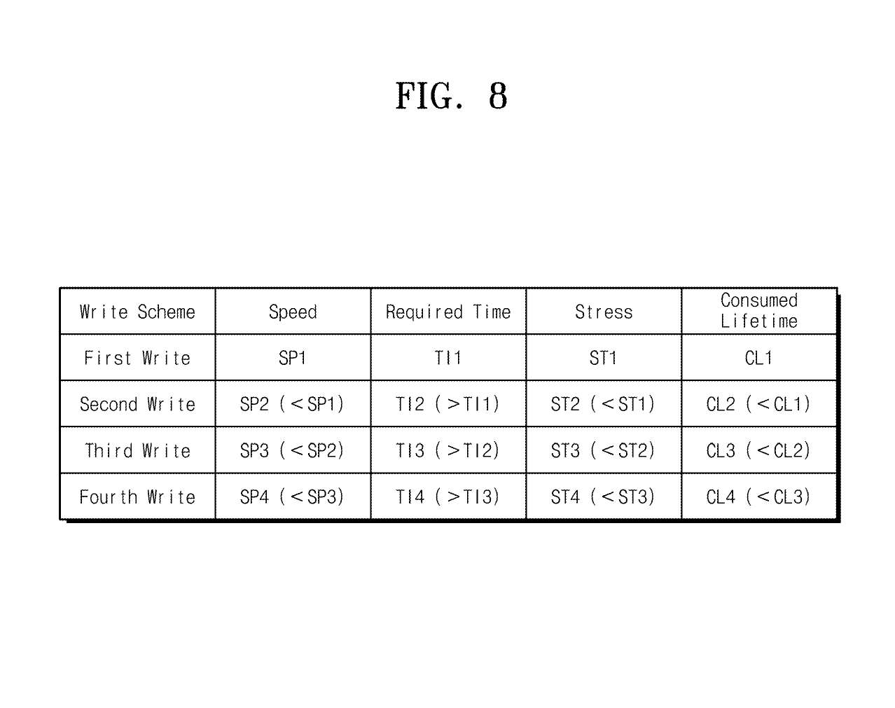

FIG. 8 is a table illustrating characteristics of first through fourth writes. Referring to FIGS. 7 and 8, a first speed SP1 of a first write is higher than a second speed SP2 of a second write. The second speed SP2 of the second write is higher than a third speed SP3 of a third write. The third speed SP3 of the third write is higher than a fourth speed SP4 of a fourth write. That is, a first time TI1 being consumed in the first write is shorter than a second time TI2 being consumed in the second write. The second time TI2 being consumed in the second write is shorter than a third time TI3 being consumed in the third write. The third time TI3 being consumed in the third write is shorter than a fourth time TI4 being consumed in the fourth write.

According to a service quality of a write command, one of the first through fourth writes may be selected. As the QoS of the write command increases, a higher speed write may be selected.

A first stress ST1 that occurs in the first write is greater than a second stress ST2 that occurs in the second write. The second stress ST2 that occurs in the second write is greater than a third stress ST3 that occurs in the third write. The third stress ST3 that occurs in the third write is greater than a fourth stress ST4 that occurs in the fourth write. That is, a first lifetime CL1 of the memory cells being consumed in the first write is longer than a second lifetime CL2 of the memory cells being consumed in the second write. The second lifetime CL2 of the memory cells being consumed in the second write is longer than a third lifetime CL3 of the memory cells being consumed in the third write. The third lifetime CL3 of the memory cells being consumed in the third write is longer than a fourth lifetime CL4 of the memory cells being consumed in the fourth write.

As described above, if a write command is received through a virtual channel for which a high QoS is required, a high speed write is performed and thereby a QoS is guaranteed. If a write command is received through a virtual channel for which a low QoS is required, a low speed write is performed and thereby a lifetime consumption of memory cells is reduced. By selectively performing a high speed write and a low speed write according to a QoS of a virtual channel, a lifetime consumption of the memory cells, that is, the storage device 100 is reduced while satisfying the QoS.

In FIGS. 7 and 8, it is described that memory cells are programmed to the erase state E and the first through third program states P1˜P3. However, the memory cells are not limited to be programmed to the erase state E and the first through third program states P1˜P3. When one bit is written in one memory cell, the memory cells may have an erase state and one program state. When three bits are written in one memory cell, the memory cells may have an erase state and seven program states. When k bits are written in one memory cell, the memory cells may have total 2^{k} number of states including an erase state.

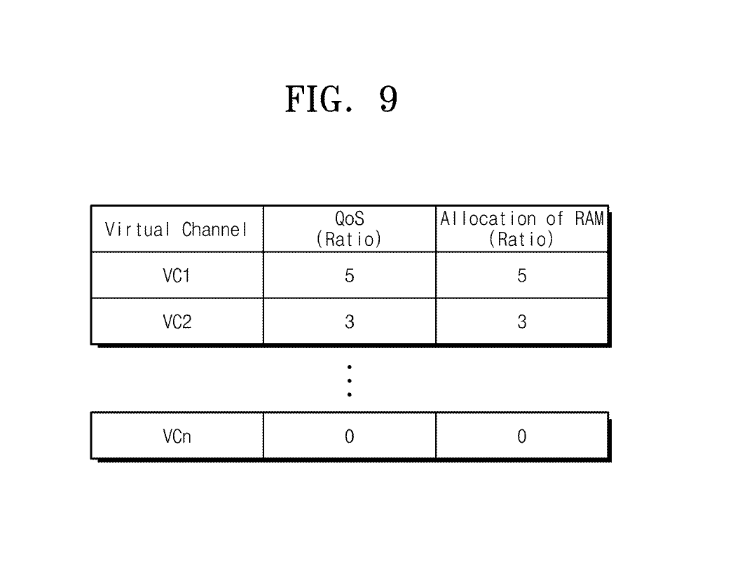

FIG. 9 illustrates another example of differently accessing a nonvolatile memory according to a QoS. Referring to FIGS. 1, 2 and 9, the RAM 130 may be divided in different ratios to be assigned according to service qualities of the virtual channels VC1˜VCn. For example, a storage space of the RAM 130 may be assigned to each of the virtual channels VC1˜VCn in the ratios that are the same as or similar to ratios of the virtual channels VC1˜VCn. For example, in the case that a service quality of the first virtual channel VC1 is 5, 50% of a storage space of the RAM 130 may be assigned to the first virtual channel VC1.

The RAM 130 may be used as a buffer memory or a cache memory between the host layer 11 and the storage layer 12. As a capacity of the assigned buffer memory or the assigned cache memory increases, operation performance of a virtual channel is improved. Thus, to satisfy different QoSs of the virtual channels VC1˜VCn, a storage space of the RAM 130 may be assigned to the virtual channels VC1˜VCn in proportion to the QoSs of the virtual channels VC1˜VCn.

Some areas of the nonvolatile memory 110 may be used as a buffer area. In this case, the buffer area of the nonvolatile memory 110 may also be divided to be assigned to the virtual channels VC1˜VCn according to the QoSs of the virtual channels VC1˜VCn.

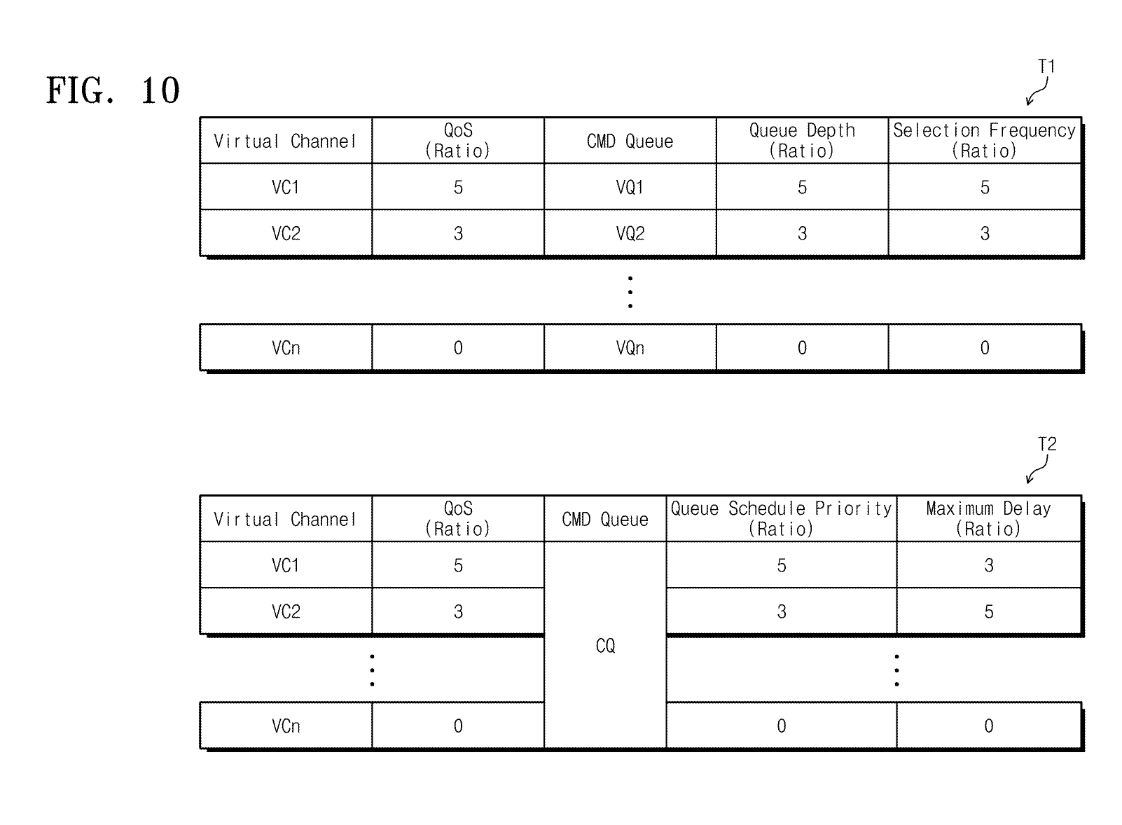

FIG. 10 illustrates still another example of differently accessing a nonvolatile memory according to a QoS. Referring to FIGS. 1 and 2 and a first table T1 of FIG. 10, a command queue CQ may be divided into a plurality of virtual queues VQ1˜VQn. The virtual queues VQ1˜VQn may be assigned to the virtual channels VC1˜VCn respectively. For example, the first virtual queue VQ1 may enqueue and schedule the second command CMD2 being received through the first virtual channel VC1 or the first command CMD1 corresponding to the second command CMD2. The kth virtual queue (k is an integer between 1 and n) may enqueue and schedule the second command CMD2 being received through the kth virtual channel VCk or the first command CMD1 corresponding to the second command CMD2.

Depending on QoSs of the virtual channels VC1˜VCn, queue depths of the virtual queues VQ1˜VQn being assigned to the virtual channels VC1˜VCn respectively may be differently set. For example, the queue depths of the virtual queues VQ1˜VQn may be set in proportion to the QoSs of the virtual channels VC1˜VCn.

Depending on QoSs of the virtual channels VC1˜VCn, selection frequencies of the virtual queues VQ1˜VQn being assigned to the virtual channels VC1˜VCn respectively may be differently set. For example, when commands enqueued in the virtual queues VQ1˜VQn are selected and executed a specific number of times, the first virtual queue VQ1 may be selected a number of times corresponding to 30% of the specific number of times.

Referring to FIGS. 1 and 2 and a second table T2 of FIG. 10, the virtual channels VC1˜VCn may use a command queue CQ in common That is, the second command CMD2 being received through the virtual channels VC1˜VCn or the first command CMD1 corresponding to the second command CMD2 may be enqueued in the command queue CQ in common.

The schedule priority of commands being enqueued in the command queue CQ may be set according to the QoSs of the virtual channels VC1˜VCn. For example, the schedule priority of commands being enqueued in the command queue CQ may be set in proportion to the QoSs of the virtual channels VC1˜VCn. After a command having a low priority is enqueued in the command queue CQ, a command having a high priority may be enqueued in the command queue CQ. When scheduling the command queue CQ, a command having a high priority may be relocated in a preceding slot compared with a command having a low priority. A command having a low priority may be relocated in a subsequent slot compared with a command having a high priority.

According to the QoSs of the virtual channels VC1˜VCn, a maximum delay of commands being enqueued in the command queue CQ may be determined. The maximum delay may be the maximum number of times that a command enqueued in the command queue CQ can be relocated to a subsequent slot when scheduling the command queue CQ. The maximum delay may be the maximum delay time until a command enqueued in the command queue CQ is selected to be performed. For example, the maximum delay of commands being enqueued in the command queue CQ may be set in inverse proportion to the QoSs of the virtual channels VC1˜VCn. A maximum delay of a virtual channel not being used may be set to a default value regardless of a QoS.

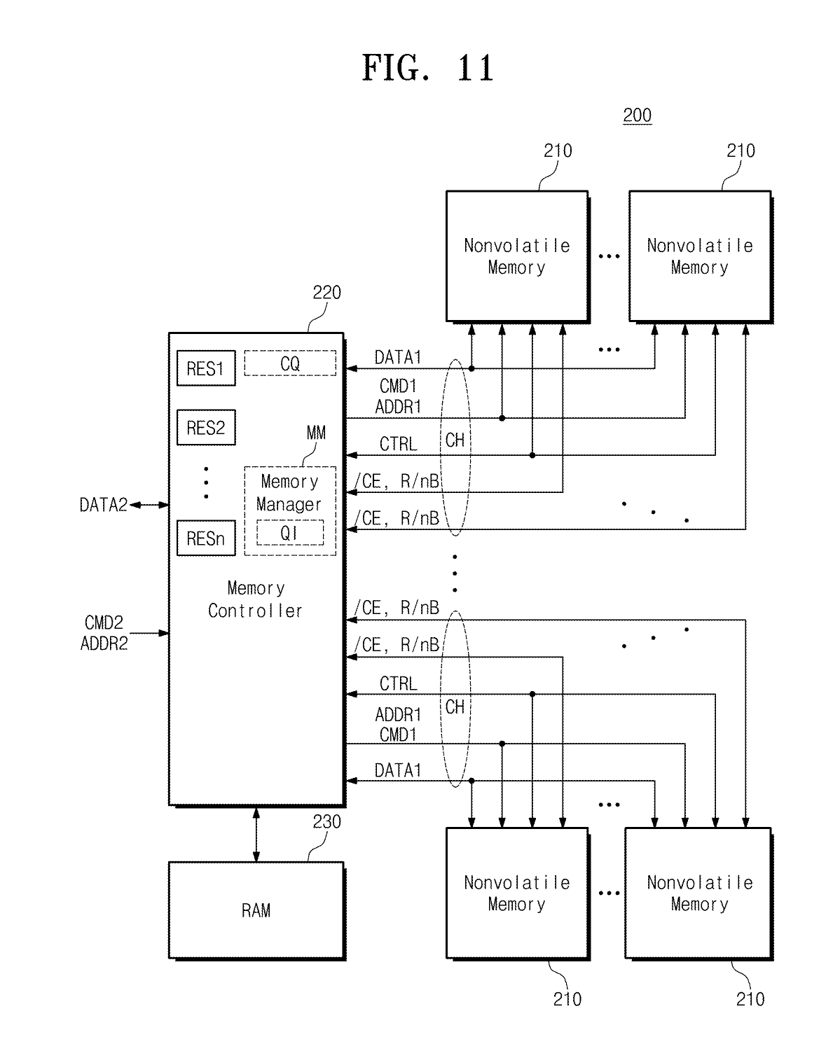

FIG. 11 is a block diagram illustrating a storage device in accordance with a second embodiment of the application. Referring to FIG. 11, a storage device 200 includes a plurality of nonvolatile memories 210, a memory controller 220 and a RAM 230.

The nonvolatile memories 210 may communicate with the memory controller 220 through a plurality of channels CH. The nonvolatile memories connected to different channels CH may communicate with the memory controller 220 independently of one another. In each channel CH, the memory controller 220 may exchange first data DATA1, a first command CMD1 and a first address ADDR1 with the nonvolatile memories 210 through a common channel. In each channel CH, the memory controller 220 may exchange a control signal CTRL with the nonvolatile memories 210 through a common channel. The control signal CTRL may include a command latch enable signal CLE, an address latch enable signal ALE, a read enable signal /RE, a write enable signal /WE, and a write prevention signal /WP.

In each channel CH, the memory controller 220 may exchange a chip enable signal /CE and a ready & busy signal R/nB with the nonvolatile memories 210 through different channels. In each channel CH, the memory controller 220 may individually select the nonvolatile memories 210 and nonvolatile memory devices 211 in the nonvolatile memory 210 by controlling the chip enable signal /CE. In each channel CH, on the basis of the ready & busy signal R/nB, the memory controller 220 may identify whether the nonvolatile memories 210 are in a state for communication.

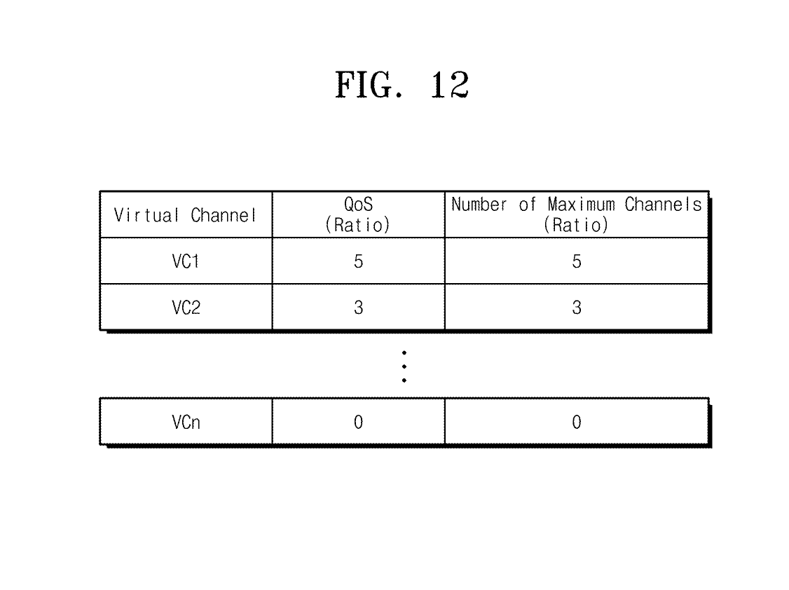

FIG. 12 illustrates yet another example of differently accessing a nonvolatile memory according to a QoS. Referring to FIGS. 1, 11 and 12, ratios of the number of maximum channels is determined according to QoSs of the virtual channels VC1˜VCn. For example, ratios of the number of maximum channels may be set in proportion to the QoSs of the virtual channels VC1˜VCn. The ratio of the number of maximum channels indicates a maximum ratio of channels that may be occupied among channels CH through which the memory controller 220 communicates with the nonvolatile memories 210.

The memory controller 220 may communicate with the nonvolatile memories 210 through m number of channels. A command corresponding to the first virtual channel VC1 may be performed using 50% of the m number of channels at the same time or in parallel. A command corresponding to the second virtual channel VC2 may be performed using 30% of the m number of channels at the same time or in parallel.

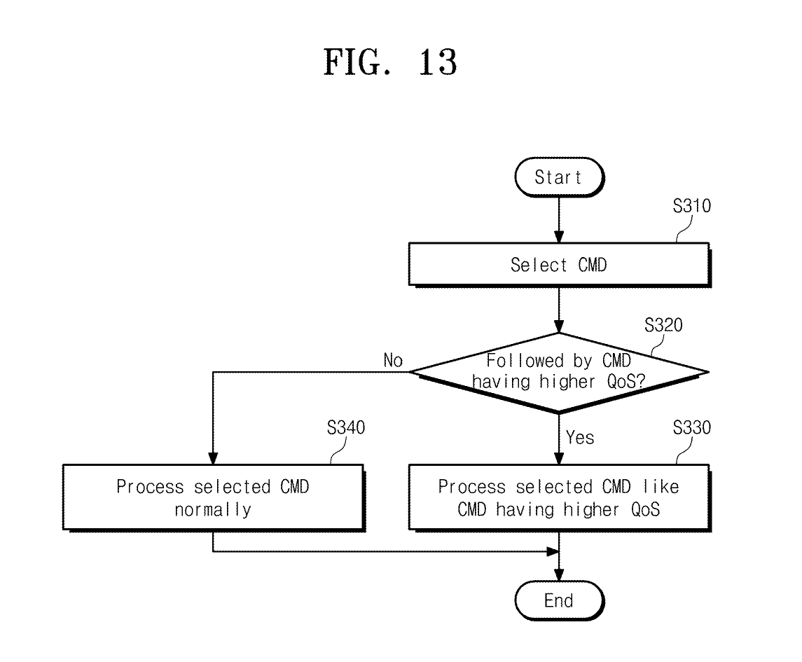

FIG. 13 illustrates still yet another example of differently accessing a nonvolatile memory according to a QoS. Referring to FIGS. 1, 2 and 13, in a step S310, the memory controller 120 may select one command among commands registered in the command queue CQ.

In a step S320, the memory controller distinguishes whether a QoS of a command subsequent to the command selected in the command queue CM is higher than the QoS of the selected command. For example, as described with reference to the first table T1 of FIG. 10, a QoS of a subsequent virtual queue VQ may be compared with a QoS of a virtual queue VQ to which the selected command belongs. For another example, as described with reference to the second table T2 of FIG. 10, a QoS of a subsequent command may be compared with a QoS of the selected command in the same command queue CQ.

If the QoS of a subsequent command is higher than the QoS of the selected command, in a step S330, the selected command is processed as though it has a higher QoS requirement. For example, the selected command may be processed to have the same QoS as the subsequent command.

If the QoS of a subsequent command is not higher than the QoS of the selected command, in a step S340, the selected command is normally processed. For example, the selected command may be processed according to a corresponding QoS.

As described with reference to FIG. 11, the memory controller 220 may be configured to communicate with the nonvolatile memories 210 through a plurality of channels CH. In this case, the method illustrated in FIG. 13 may be performed only on commands which belong to the same channel CH. Since commands are processed in parallel in different channels CH, the method illustrated in FIG. 13 may not be performed on commands corresponding to different channels CH.

The memory controller 220 may include a plurality of command queues corresponding to the channels CH respectively. The memory controller 220 may perform the method of FIG. 13 in each of the command queues.

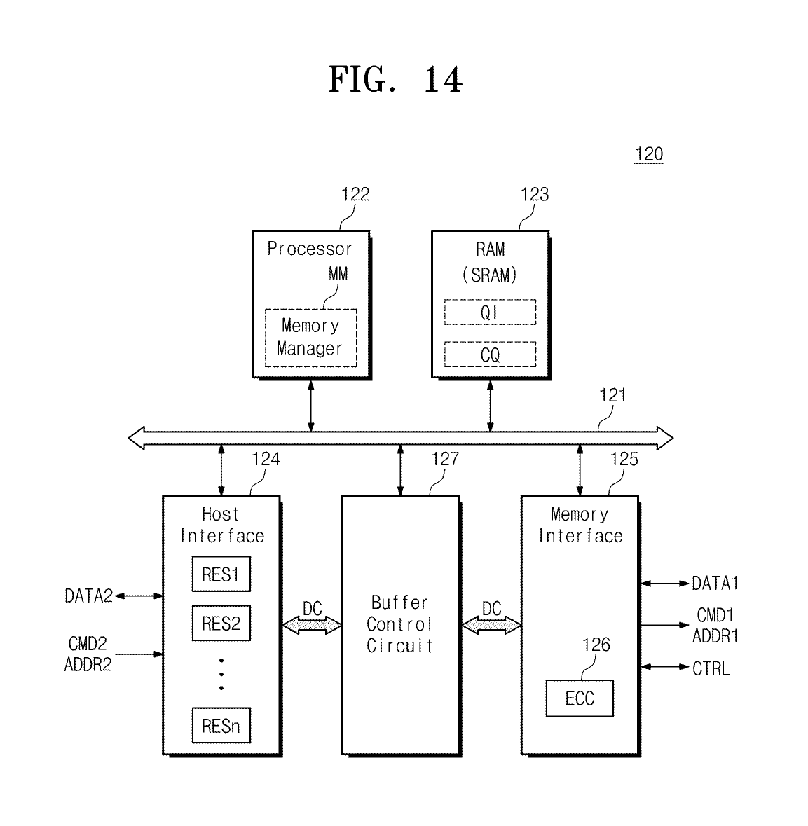

FIG. 14 is a block diagram illustrating a memory controller in accordance with an embodiment of the application. Referring to FIGS. 1, 2 and 14, the memory controller 120 includes a bus 121, a processor 122, a RAM 123, a host interface 124, a memory interface 125, and a buffer control circuit 127.

The bus 121 is configured to provide a channel among constituent elements of the memory controller 120. For example, a second command CMD2 and a second address ADDR2 being received from an external host device to the memory controller 120 may be transmitted to the processor 122 through the bus 121. The processor 122 may generate a first command CMD1 and a first address ADDR1 based on the second command CMD2 and the second address ADDR2. The first command CMD1 and the first address ADDR1 may be transmitted to the memory interface 125 through the bus 121. That is, the bus 121 may provide a route through which a command and an address are transmitted among the host interface 124, the processor 122 and the memory interface 125. The bus 121 may provide a control channel through which the processor 122 controls the host interface 124, the memory interface 125 and the buffer control circuit 127. The bus 121 may provide an access channel through which the processor 122 accesses the RAM 123.

The processor 122 may control an overall operation of the memory controller 120 and perform a logical operation. The processor 122 may communicate with an external host device through the host interface 125. The processor 122 may store the second command CMD2 or the second address ADDR2 being received through the host interface 125 in the RAM 123. The processor 122 may generate the first command CMD1 and the first address ADDR1 based on the command or the address stored in the RAM 123 and output the generated first command CMD1 and the generated first address ADDR1 through the memory interface 125.

For example, the second address ADDR2 may be a logical address being used in a host device and the first address ADDR1 may be a physical address being used in the nonvolatile memory 110. The processor 122 may load information being used when converting the second address ADDR2 into the first address ADDR1 in the RAM 123 and refer to the information loaded into the RAM 123.

The processor 122 may exercise control so that data being received through the host interface 125 is output through the buffer control circuit 127. The processor 122 may exercise control so that data being received through the buffer control circuit 127 is transmitted to the memory interface 125. The processor 122 may exercise control so that data being received through the memory interface 125 is output through the buffer control circuit 127. The processor 122 may exercise control so that data being received through the buffer control circuit 127 is output through the host interface 124 or the memory interface 125. The processor 122 may drive the memory manager MM.

The RAM 123 may be used as an operation memory, a cache memory or a buffer memory of the processor 122. The RAM 123 may store codes and commands which the processor 122 executes. The RAM 123 may store data being processed by the processor 122. The RAM 123 may include a static RAM (SRAM). The RAM 123 may store a command queue CQ and QoS information QI.

The host interface 124 is configured to communicate with an external host device under the control of the processor 122. The host interface 124 may be configured to communicate using at least one of various communication methods such as a universal serial bus (USB), a serial at attachment (SATA), a serial attached SCSI (SAS), a high speed interchip (HSIC), a small computer small interface (SCSI), a Firewire, a peripheral component interconnection (PCI), a PCI express (PCIe), a nonvolatile memory express (NVMe), a universal flash storage (UFS), a secure digital (SD), a multimedia card (MMC), an embedded MMC (eMMC), etc.

The host interface 124 may transmit the second command CMD2 and the second address ADDR2 being received from the host device to the processor 122 through the bus 121. The host interface 124 may transmit second data DATA2 being received from the host device to the buffer control circuit 127 through a data channel DC. The host interface 124 may output the second data DATA2 being received from the buffer control circuit 127 to the host device.

The host interface 124 may include a plurality of register sets RES1˜RESn.

The memory interface 125 is configured to communicate with the nonvolatile memory 110 under the control of the processor 122. The memory interface 125 may receive the first command CMD1 and the first address ADDR1 from the processor 122 through the bus 121. The memory interface 125 may output the first command CMD1 and the first address ADDR1 to the nonvolatile memory 110. The memory interface 125 may generate a control signal CTRL on the basis of the first command CMD1 and the first address ADDR1 and output the generated control signal CTRL to the nonvolatile memory 110.

The memory interface 125 may receive the first data DATA1 from the buffer control circuit 127 through the data channel DC. The memory interface 125 may output the first data DATA1 received through the data channel DC to the nonvolatile memory 110. The memory interface 125 may receive the control signal CTRL and the first data DATA1 from the nonvolatile memory 110. The memory interface 125 may transmit the first data DATA1 being received from the nonvolatile memory 110 to the buffer control circuit 127 through the data channel DC.

The memory interface 125 includes an error correction (ECC) block 126. The error correction block 126 may perform an error correction. The error correction block 126 may generate a parity for performing an error correction on the basis of the first data DATA1 being output to the nonvolatile memory 110 through the memory interface 125. The generated parity may be written in the nonvolatile memory 110 together with the first data DATA1. When the first data DATA1 is received from the nonvolatile memory 110, parity related to the first data DATA1 may be received together. The error correction block 126 may perform an error correction of the first data DATA1 using the first data DATA1 and the parity being received through the memory interface 125.

The buffer control circuit 127 is configured to control the RAM 130 under the control of the processor 122. The buffer control circuit 127 may write data in the RAM 130 and read data from the RAM 130.

The processor 122 may control the memory controller 120 using codes. The processor 122 may read codes being provided to the inside of the memory controller 120 from a nonvolatile memory (for example, a read only memory) and may store the read codes in the RAM 123 to execute them.

The memory interface 125 or the processor 122 may further perform randomization with respect to the first data DATA1 being written in the nonvolatile memory 110. The randomization may be an operation of coding the first data DATA1 arbitrarily or according a predetermined rule so that a specific pattern is prevented from occurring in the first data DATA1. The memory interface 125 or the processor 122 may further perform de-randomization with respect to the first data DATA1 being read from the nonvolatile memory 110.

The memory interface 125 or the processor 122 may further perform an encryption that improves security of the first data DATA1 being written in the nonvolatile memory 110. The memory interface 125 or the processor 122 may further perform decryption with respect to the first data DATA1 being read from the nonvolatile memory 110. The encryption and the decryption may be performed according to a standard protocol such as DES (data encryption standard), AES (advanced encryption standard), etc.

The memory controller 120 may be configured to provide auxiliary power. For example, the memory controller 120 may store power being supplied from the host device in a charging station such as a super cap. When power being supplied from the host device is suddenly interrupted, the memory controller 120 may use the power stored in the charging station as auxiliary power. Using the auxiliary power, the memory controller 120 may perform a backup operation with respect to an operation state of the memory controller 120 or write data not written in the nonvolatile memory 110 yet. The memory controller 120 may perform a normal power off sequence using the auxiliary power.

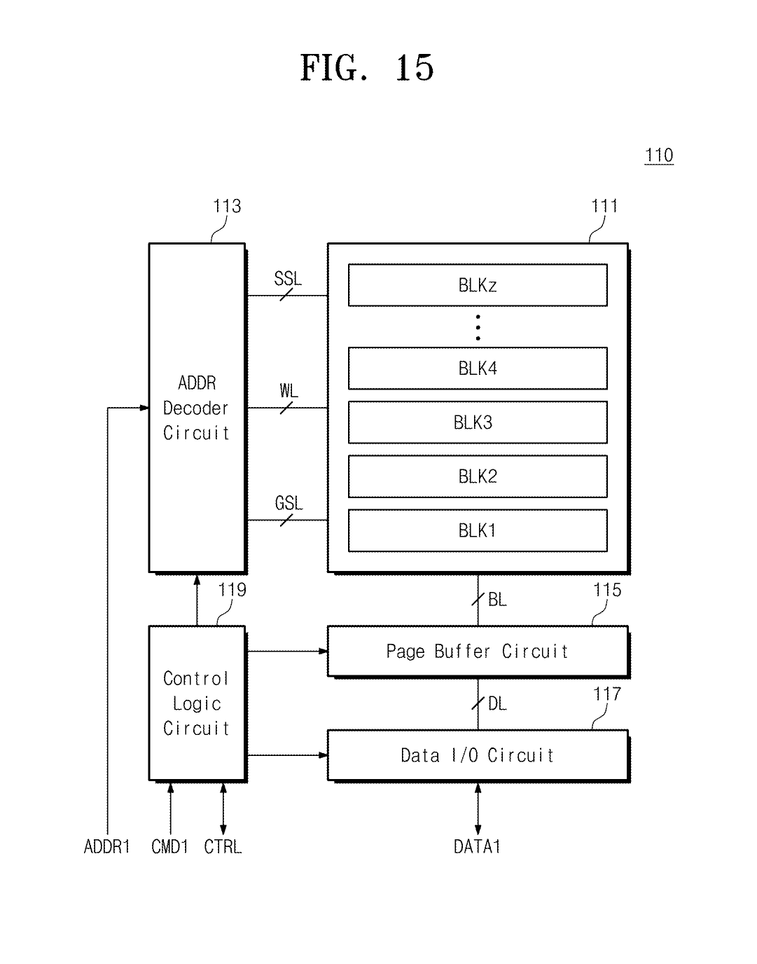

FIG. 15 is a block diagram illustrating a nonvolatile memory in accordance with an embodiment of the application. Referring to FIGS. 2 and 15, the nonvolatile memory 110 includes a memory cell array 111, an address decoder circuit 113, a page buffer circuit 115, a data input/output circuit 117 and a control logic circuit 119.

The memory cell array 111 includes a plurality of memory blocks BLK1˜BLKz. Each memory block includes a plurality of memory cells. Each memory block may be connected to the address decoder circuit 113 through at least one ground select line GSL, a plurality of word lines WLs and at least one string select line SSL. Each memory block may be connected to the page buffer circuit 115 through a plurality of bit lines BLs. The memory blocks BLK1˜BLKz may be connected to the bit lines BLs in common Memory cells of the memory blocks BLK1˜BLKz may have the same structures. Each of the memory blocks BLK1˜BLKz may be an erase operation unit. Memory cells of the memory cell array 111 may be erased by one memory block unit. Memory cells included in one memory block may be erased at the same time.

The address decoder circuit 113 is connected to the memory cell array 111 through a plurality of ground select lines GSL, a plurality of word lines WLs, and a plurality of string select lines SSL. The address decoder circuit 113 operates under the control of the control logic circuit 119. The address decoder circuit 113 may receive a first address ADDR1 from the memory controller 120. The address decoder circuit 113 may decode the received first address ADDR1 and control voltages being applied to the word lines WLs according to the decoded address.

In a program operation, the address decoder circuit 113 may apply a program voltage VGPM to a selected word line of a selected memory block which the first address ADDR1 indicates and apply a pass voltage VPASS to unselected word lines of the selected memory block. In a read operation, the address decoder circuit 113 may apply a read voltage VGD to a selected word line of a selected memory block which the first address ADDR1 indicates and apply an erase voltage (e.g., a ground voltage) to unselected word lines of the selected memory block.

The page buffer circuit 115 is connected to the memory cell array 111 through the bit lines BLs. The page buffer circuit 115 is connected to the data input/output circuit 117 through the data lines DLs. The page buffer circuit 115 operates according to a control of the control logic circuit 119.

The page buffer circuit 115 may store data to be programmed in memory cells of the memory cell array 111 or data being read from the memory cells. In a program operation, the page buffer circuit 115 may store data to be programmed in the memory cells. On the basis of the stored data, the page buffer circuit 115 may bias the bit lines BLs. In a program operation, the page buffer circuit 115 may function as a write driver. In a read operation, the page buffer circuit 115 may sense voltages of the bit lines BLs and store the sensing result. In a read operation, the page buffer circuit 115 may function as a sensing amplifier.

The data input/output circuit 117 is connected to the page buffer circuit 115 through the data lines DLs. The data input/output circuit 117 may exchange the first data DATA1 with the memory controller 120.

The data input/output circuit 117 may temporarily store the first data DATA1 being received from the memory controller 120. The data input/output circuit 117 may transmit the stored data to the page buffer circuit 115. The data input/output circuit 117 may temporarily store the data DATA1 being transmitted from the page buffer circuit 115. The data input/output circuit 117 may transmit the stored data to the memory controller 120. The data input/output circuit 117 may function as a buffer memory.

The control logic circuit 119 receives the first command CMD1 and the control signal CTRL from the memory controller 120. The control logic circuit 119 may decode the received first command CMD1 and control an overall operation of the nonvolatile memory 110 according to the decoded command.

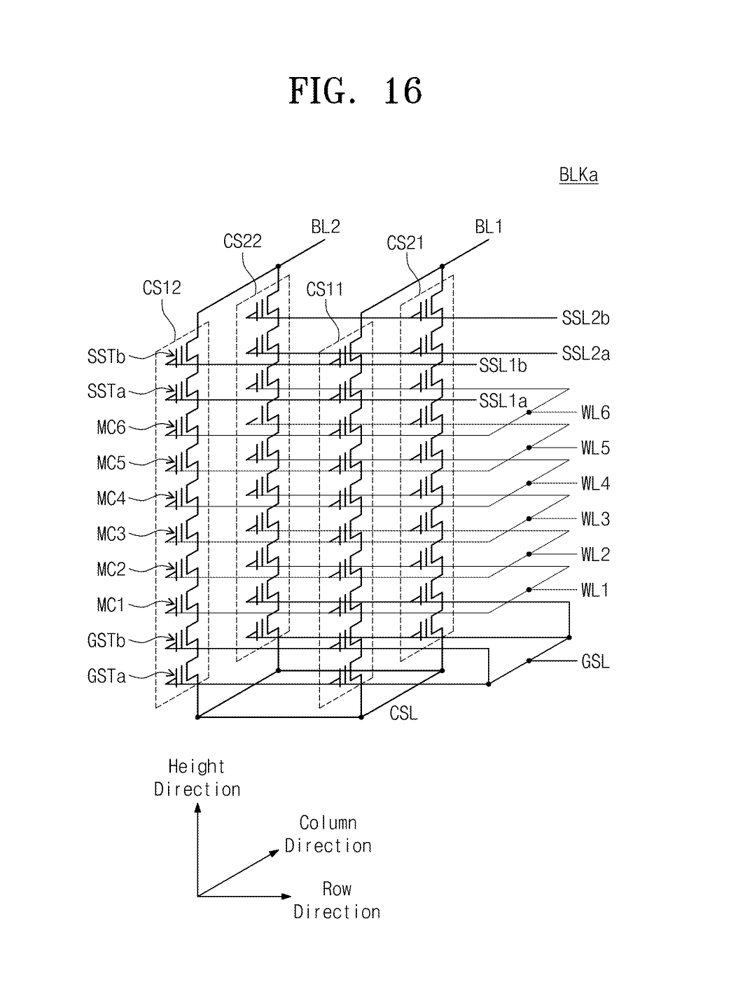

FIG. 16 is a circuit illustrating a memory block in accordance with an embodiment of the application. Referring to FIG. 16, a memory block BLKa includes a plurality of cell strings (CS11˜CS21, CS12˜CS22). The cell strings (CS11˜CS21, CS12˜CS22) are arranged in row and column directions to form rows and columns.

For example, the cell strings CS11 and CS12 arranged along a row direction may form a first row and the cell strings CS21 and CS22 arranged along a row direction may form a second row. The cell strings CS11 and CS21 arranged along a column direction may form a first column and the cell strings CS12 and CS22 arranged along a column direction may form a second column.

Each cell string may include a plurality of cell transistors. The cell transistors include ground select transistors GSTa and GSTb, memory cells MC1˜MC6 and string select transistors SSTa and SSTb. The ground select transistors GSTa and GSTb, the memory cells MC1˜MC6 and the string select transistors SSTa and SSTb of each cell string may be stacked in a direction perpendicular to a plane (for example, a plane on a substrate of the memory block BLKa) on which the cell strings (CS11˜CS21, CS12˜CS22) are arranged along rows and columns.

The cell transistors may be charge trap type transistors having threshold voltages that vary according to charge amounts trapped in an insulation layer.

The lowermost ground select transistors GSTa may be connected to a common source line CSL in common.

The ground select transistors GSTa and GSTb of the cell strings (CS11˜CS21, CS12˜CS22) may be connected to the ground select line GSL in common.

Ground select transistors having the same height (or order) may be connected to the same ground select line and ground select transistors having different heights (or orders) may be connected to different ground select lines. For example, the ground select transistors GSTa having a first height may be connected to a first ground select line in common and the ground select transistors GSTb having a second height may be connected to a second ground select line in common.

Ground select transistors having the same row may be connected to the same ground select line and ground select transistors having different rows may be connected to different ground select lines. For example, the ground select transistors GSTa and GSTb of the cell strings CS11 and CS12 of a first row may be connected to a first ground select line and the ground select transistors GSTa and GSTb of the cell strings CS21 and CS22 of a second row may be connected to a second ground select line. The ground select transistors GSTa of cell strings CS11, CS12, CS21, and CS22 may be connected to a common source line CSL.

Memory cells located at the same height from a substrate (or ground select transistors GST) may be connected to one word line in common and memory cells located at different heights from the substrate may be connected to different word lines WL1˜WL6 respectively. For example, the memory cells MC1 are connected to the word line WL1 in common. The memory cells MC2 are connected to the word line WL2 in common. The memory cells MC3 are connected to the word line WL3 in common. The memory cells MC4 are connected to the word line WL4 in common. The memory cells MC5 are connected to the word line WL5 in common. The memory cells MC6 are connected to the word line WL6 in common.

In the first string select transistors SSTa of the same height of the cell strings (CS11˜CS21, CS12˜CS22), the first string select transistors SSTa of different rows are connected to different string select lines SSL1a˜SSL2a respectively. For example, the first string select transistors SSTa of the cell strings CS11 and CS12 are connected to the string select line SSLla in common. The first string select transistors SSTa of the cell strings CS21 and CS22 are connected to the string select line SSL2a in common.

In the second string select transistors SSTb of the same height of the cell strings (CS11˜CS21, CS12˜CS22), the second string select transistors SSTa of different rows are connected to different string select lines SSL1b˜SSL2b respectively. For example, the second string select transistors SSTb of the cell strings CS11 and CS12 are connected to the string select line SSL1b in common. The second string select transistors SSTb of the cell strings CS21 and CS22 are connected to the string select line SSL2b in common.

That is, cell strings of different rows are connected to different string select lines. String select transistors of the same height of cell strings of the same row are connected to the same string select line. String select transistors of different heights of cell strings of the same row are connected to different string select lines.

String select transistors of cell strings of the same row may be connected to a string select line in common. For example, the string select transistors SSTa and SSTb of the cell strings CS11 and CS12 of the first row may be connected to on string select line in common. The string select transistors SSTa and SSTb of the cell strings CS21 and CS22 of the second row may be connected to on string select line in common.

Columns of the cell strings (CS11˜CS21, CS12˜CS22) are connected to different bit lines BL1 and BL2 respectively. For example, the string select transistors SSTb of the cell strings CS11˜CS21 of the first column are connected to the bit line BL1 in common. The string select transistors SSTb of the cell strings CS12˜CS22 of the second column are connected to the bit line BL2 in common.

The cell strings CS11 and CS12 may form a first plane. The cell strings CS21 and CS22 may form a second plane.

In the memory block BLKa, a write or read operation may be performed by a row unit. For example, one plane of the memory block BLKa may be selected by the string select lines SSL1a, SSL1b, SSL2a and SSL2b. When a turn-on voltage is supplied to the string select lines SSL1a and SSL1b and a turn-off voltage is supplied to the string select lines SSL2a and SSL2b, the cell strings CS11 and CS12 of the first plane are connected to the bit lines BL1 and BL2. That is, the first plane is selected. When a turn-on voltage is supplied to the string select lines SSL2a and SSL2b and a turn-off voltage is supplied to the string select lines SSL1a and SSL1b, the cell strings CS21 and CS22 of the second plane are connected to the bit lines BL1 and BL2. That is, the second plane is selected. In the selected plane, one row of the memory cells MC may be selected by the word lines WL1˜WL6. In the selected row, a write or read operation may be performed.

In the memory block BLKa, an erase operation may be performed by a block unit or a sub block unit. When an erase operation is performed by a memory block unit, all the memory cells MC of the memory block BLKa may be erased at the same time according to one erase request. When an erase operation is performed by a sub block unit, some of the memory cells MC of the memory block BLKa may be erased at the same time according to one erase request and the remaining memory cells may be erase-prohibited. A low voltage (for example, a ground voltage) may be supplied to a word line connected to the memory cells being erased and a word line connected to the erase-prohibited memory cells may be floated.

The memory block BLKa illustrated in FIG. 16 is illustrative, and a technical spirit of the application is not limited thereto. For example, the number of rows and columns of the cell strings may be increased or decreased. As the number of rows and columns of the cell strings is changed, the number of cell string lines or ground select lines connected to rows of the cell strings, and the number of cell strings connected to one bit line may be changed.

A height of the cell strings may be increased or decreased. For example, the number of ground select transistors, memory cells or string select transistors being stacked on each cell string may be increased or decreased.

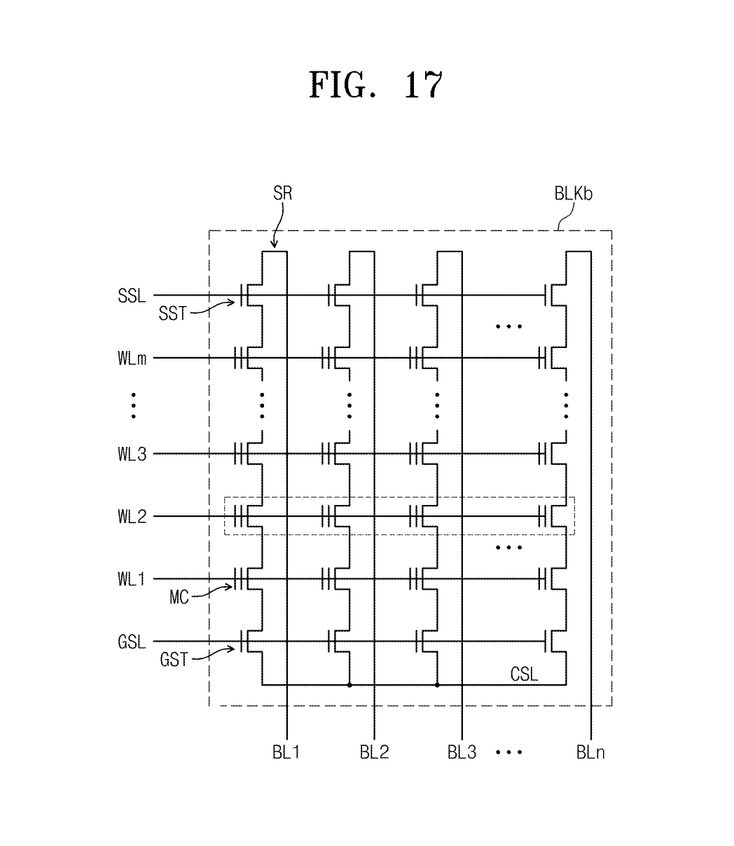

FIG. 17 is a circuit illustrating a memory block in accordance with another embodiment of the application. Referring to FIG. 17, a memory block BLKb includes a plurality of strings SR. The strings SR may be connected to a plurality of bit lines BL1˜BLn respectively. Each string SR includes a ground select transistor GST, memory cells MC and a string select transistor SST.

The ground select transistor of each string SR is connected between the memory cells MC and a common source line CSL. The ground select transistors GST of the cell strings SR are connected to the common source line CSL in common.

The string select transistor SST of each string SR is connected between the memory cells MC and the bit line BL. The string select transistors SST of the strings SR are connected to the bit lines BL1˜BLn respectively.

In each string SR, the memory cells MC are connected between the ground select transistor GST and the string select transistor SST. In each string SR, the memory cells MC may be serially connected to one another.

In the strings SR, memory cells MC located at the same order from the common source line CSL may be connected to one word line in common. The memory cells MC of the strings SR may be connected to a plurality of word lines WL1˜WLm respectively. The string selection transistor SST included in each of the memory cell strings SR may be commonly connected to the string selection line SSL. The ground selection transistor GST included in each of the memory cell strings SR may be commonly connected to the ground selection line GSL.

In the memory block BLKb, an erase operation may be performed by a memory block unit. When an erase operation is performed by a memory block unit, all the memory cells MC of the memory block BLKb may be erased at the same time according to one erase request.

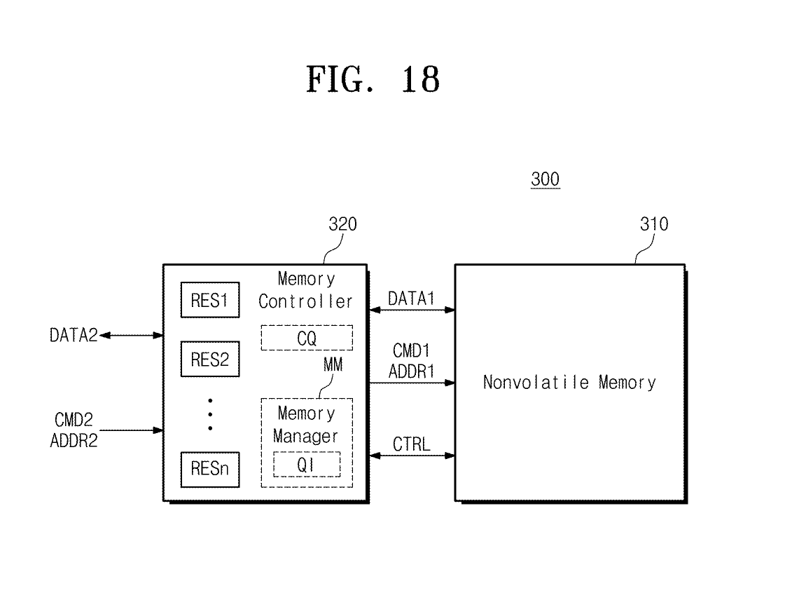

FIG. 18 is a block diagram illustrating a storage device in accordance with a third embodiment of the application. Referring to FIG. 18, a storage device 300 includes a nonvolatile memory 310 and a memory controller 320.

As compared with the storage device 100 of FIG. 2, an external RAM of the memory controller 320 is not provided to the storage device 300. The storage device 300 may perform the functions described with reference to the RAM 130 of FIG. 2 using an internal RAM of the memory controller 320. Accordingly, a detailed description of these functions is not repeated here.

The storage device 300 may be mounted on mobile devices such as a smart phone, a smart pad, a smart camera, a wearable device, etc.

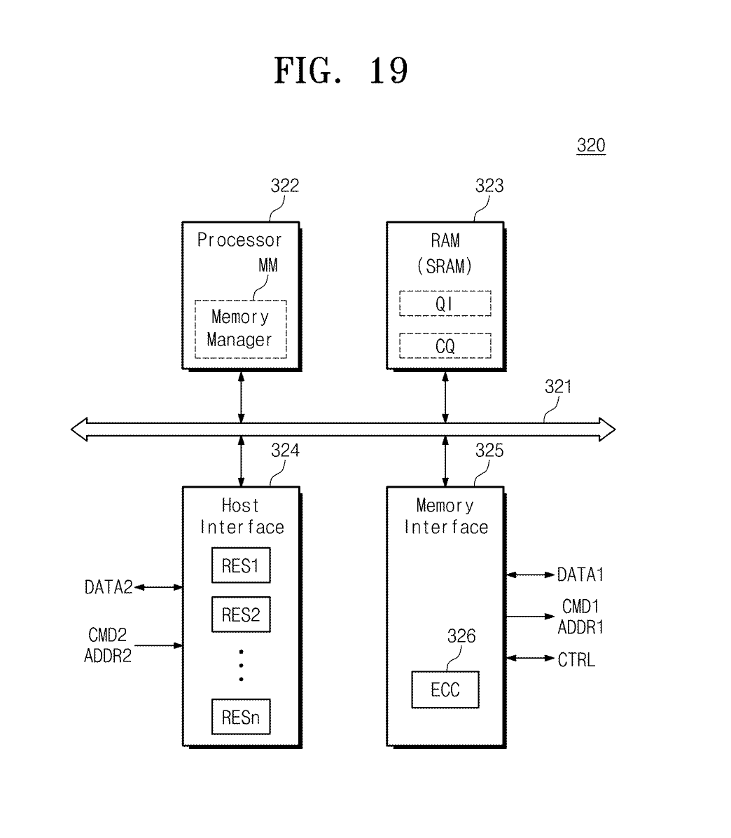

FIG. 19 is a block diagram illustrating a memory controller in accordance with another embodiment of the application. Referring to FIG. 19, the memory controller 320 includes a bus 321, a processor 322, a RAM 323, a host interface 324 and a memory interface 325.

The bus 321 is configured to provide a channel between constituent elements.

The processor 322 may control an overall operation of the memory controller 320 and perform a logical operation. The processor 322 may communicate with an external host through the host interface 325. The processor 322 may store a second command CMD2 and a second address ADDR2 being received through the host interface 324 in the RAM 323. The processor 322 may generate a first command CMD1 and a first address ADDR1 according to a command or an address stored in the RAM 323 and output the generated first command CMD1 and the generated first address ADDR1 through the memory interface 325.

For example, the second address ADDR2 may be a logical address being used in a host device and the first address ADDR1 may be a physical address being used in the nonvolatile memory 310. The processor 322 may load information being used when converting the second address ADDR2 into the first address ADDR1 and refer to the information loaded into the RAM 323.

The processor 322 may store second data DATA2 being received through the host interface 325 in the RAM 323. The processor 322 may transmit the data stored in the RAM 323 to the memory interface 325 as first data DATA1. The processor 322 may store the first data DATA1 being received through the memory interface 325 in the RAM 323. The processor 322 may output the data stored in the RAM 323 as second data DATA2 through the host interface 324. The processor 322 may drive the memory manager MM.

The RAM 323 may be used as an operation memory, a cache memory or a buffer memory of the processor 322. The RAM 323 may store codes and commands which the processor 322 executes. The RAM 323 may store data being processed by the processor 322. The RAM 323 may store the first data DATA1 being written in the nonvolatile memory 310 or the first data DATA1 being read from the nonvolatile memory 310. The RAM 323 may include a static RAM (SRAM). The RAM 323 may store command queue CQ and QoS information QI.

The host interface 324 is configured to communicate with an external host device under the control of the processor 322. The host interface 324 may be configured to communicate using at least one of various communication methods such as a universal serial bus (USB), a serial at attachment (SATA), a serial attached SCSI (SAS), a high speed interchip (HSIC), a small computer small interface (SCSI), a Firewire, a peripheral component interconnection (PCI), a PCI express (PCIe), a nonvolatile memory express (NVMe), a universal flash storage (UFS), a secure digital (SD), a multimedia card (MMC), an embedded MMC (eMMC), etc.

The host interface 324 may transmit the second command CMD2 and the second address ADDR2 being received from the host device to the processor 322 through the bus 321. The host interface 324 may transmit second data DATA2 being received from the host device to RAM 323 through the bus 321. The host interface 324 may output the second data DATA2 being transmitted from the RAM 323 through the bus 321 to the host device. The host interface 324 may include a plurality of register sets RES1˜RESn.

The memory interface 325 is configured to communicate with the nonvolatile memory 310 under the control of the processor 322. The memory interface 325 may receive the first command CMD1 and the first address ADDR1 from the processor 322 through the bus 321. The memory interface 325 may output the first command CMD1 and the first address ADDR1 to the nonvolatile memory 310. The memory interface 325 may generate a control signal CTRL on the basis of the first command CMD1 and the first address ADDR1 and output the generated control signal CTRL to the nonvolatile memory 310.

The memory interface 325 may output the first data DATA1 transmitted from the RAM 323 through the bus 321 to the nonvolatile memory 310. The memory interface 325 may receive the control signal CTRL and the first data DATA1 from the nonvolatile memory 310. The memory interface 325 may transmit the first data DATA1 being received from the nonvolatile memory 310 to the RAM 323 through the bus 321.

The memory interface 325 includes an error correction block 326. The error correction block 326 may perform an error correction. The error correction block 326 may generate a parity for performing an error correction on the basis of the first data DATA1 being output to the nonvolatile memory 110 through the memory interface 325. The generated parity may be written in the nonvolatile memory 310 together with the first data DATA1. When the first data DATA1 is received from the nonvolatile memory 310, parity related to the first data DATA1 may be received together. The error correction block 326 may perform an error correction of the first data DATA1 using the first data DATA1 and the parity being received through the memory interface 325.

The processor 322 may control the memory controller 320 using codes. The processor 322 may read codes being provided to the inside of the memory controller 320 from a nonvolatile memory (for example, a read only memory) and may store the read codes in the RAM 323 to execute them. The processor 322 may store codes being received through the memory interfaces 325 in the RAM 323 to execute them.

The memory interface 325 or the processor 322 may further perform randomization with respect to the first data DATA1 being written in the nonvolatile memory 310. The randomization may be an operation of coding the first data DATA1 arbitrarily or according a predetermined rule so that a specific pattern is prevented from occurring in the first data DATA1. The memory interface 325 or the processor 322 may further perform de-randomization with respect to the first data DATA1 being read from the nonvolatile memory 310.

The memory interface 325 or the processor 322 may further perform an encryption that improves security of the first data DATA1 being written in the nonvolatile memory 310. The memory interface 325 or the processor 322 may further perform decryption with respect to the first data DATA1 being read from the nonvolatile memory 310. The encryption and the decryption may be performed according to a standard protocol such as DES (data encryption standard), AES (advanced encryption standard), etc.

The memory controller 320 may be configured to provide auxiliary power. For example, the memory controller 320 may store power being supplied from the host device in a charging station such as a super cap. When power being supplied from the host device is suddenly interrupted, the memory controller 320 may use the power stored in the charging station as auxiliary power. Using the auxiliary power, the memory controller 320 may perform a backup operation with respect to an operation state of the memory controller 320 or write data not written in the nonvolatile memory 110 yet. The memory controller 320 may perform a normal power off sequence using the auxiliary power.

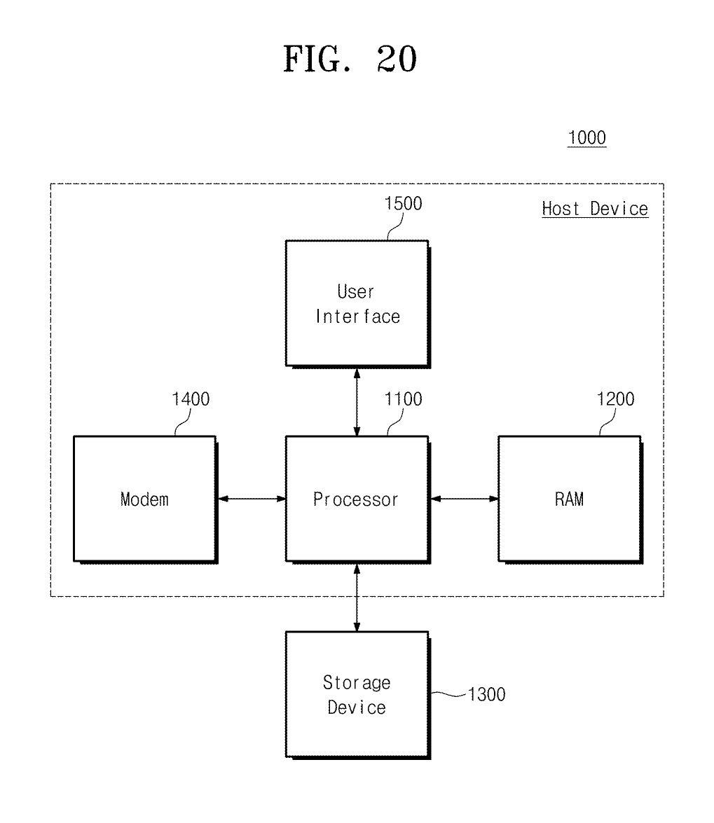

FIG. 20 is a block diagram illustrating a computing device in accordance with an embodiment of the application. Referring to FIG. 20, a computing device 1000 includes a processor 1100, a memory 1200, a storage device 1300, a modem 1400, and a user interface 1500.

The processor 1100 may control an overall operation of the computing device 1000 and perform a logical operation. For example, the processor 1100 may be constituted by a system-on-chip. The processor 1100 may be a general-purpose processor, a special-purpose processor, or an application.

The RAM 1200 may communicate with the processor 1100. The RAM 1200 may be a main memory of the processor 1100 or the computing device 1000. The processor 1100 may temporarily store code or data in the RAM 1200. The processor 1100 may execute code using the RAM 1200 and process data. The processor 1100 may execute various software such as an operating system, an application, etc. using the RAM 1200. The processor 1100 may control an overall operation of the computing device 1000 using the RAM 1200. The RAM 1200 may include a volatile memory such as an SRAM, a DRAM, an SDRAM, etc. and a nonvolatile memory such as a PRAM, an MRAM, an RRAM, an FeRAM, etc.

The storage device 1300 may communicate with the processor 1100. The storage device 1300 may store data which has to be stored for a long time. That is, the processor 1100 may store data which has to be stored for a long time in the storage device 1300. The storage device 1300 may store a boot image to drive the computing device 1000. The storage device 1300 may store source code of various software such as an operating system, an application, etc. The storage device 1300 may store data processed by various software such as an operating system, an application, etc.

The processor 1100 may drive various software such as an operating system, an application, etc. by loading source code stored into the storage device 1300 in the RAM 1200 and executing the code loaded into the RAM 1200. The processor 1100 may load data stored into the storage device 1300 in the RAM 1200 and process data loaded into the RAM 1200. The processor 1100 may store data desired to be preserved for a long time among data stored in the RAM 1200 in the storage device 1300.

The storage device 1300 may include a volatile memory such as a flash memory, a PRAM, an MRAM an RRAM, an FRAM, etc.

The modem 1400 may perform a communication with an external device according to a control of the processor 1100. For example, the modem 1400 may perform a wired or wireless communication with an external device. The modem 140 may perform a communication based on at least one of various wireless communication methods such as a long term evolution (LTE), a WiMax, a global system for mobile communication (GSM), a code division multiple access (CDMA), a Bluetooth, a near field communication (NFC), a WiFi, a radio frequency Identification (RFID), or at least one of various wired communication methods such as a universal serial bus (USB), a serial at attachment (SATA), a small computer small interface (SCSI), a Firewire, a peripheral component interconnection (PCI), a PCI express (PCIe), a nonvolatile memory express (NVMe), a universal flash storage (UFS), a secure digital (SD), a SDIO, a universal asynchronous receiver transmitter (UART), a SPI (serial peripheral interface), a high speed SPI (HS-SPI), an RS232, an inter-integrated circuit (I2C), a HS-I2C, an integrated-interchip sound (I2S), a sony/philips digital interface (S/PDIF), a multimedia card (MMC), an embedded MMC (eMMC), etc.

The user interface 1500 may communicate with a user under the control of the processor 1100. For example, the user interface 1500 may include user input interfaces such as a keyboard, a keypad, a button, a touch panel, a touch screen, a touch pad, a touch ball, a camera, a mike, a gyroscope sensor, a vibration sensor, etc. The user interface 1500 may include user output interfaces such as a liquid crystal display (LCD), an organic light emitting diode (OLED) display, an active matrix OLED (AMOLED) display, a LED, a speaker, a motor, etc.

The storage device 1300 may include at least one of the storage devices 100, 200 and 300 in accordance with some embodiments of the application. The user interface 1500 may form a host device communicating with storage device 1300. The host device may drive the host layer 11 described with reference to FIG. 1.

The host device may drive a plurality of virtual machines VM1˜VMn and communicate with the storage device 1300 through the virtual machines VM1˜VMn. That is, the host device may recognize that the plural storage devices 1300 exist due to the virtual channels VC1˜VCn. The host device may assign QoSs to the virtual machines VM1˜VMn or the virtual channels VC1˜VCn respectively. The host device may transmit the assigned QoSs to the storage device 1300 as QoS information QI.

The storage device 1300 may communicate with the processor 1100, the RAM 1200, the modem 1400 and the user interface 1500 through the virtual channels VC1˜VCn. The storage device 1300 may process commands being received through the virtual channels VC1˜VCn using different methods according to QoSs of the virtual channels VC1˜VCn.

According to the embodiments of the application, according to QoSs being required in virtual channels corresponding to virtual machines, a storage device accesses a nonvolatile memory using different methods. Thus, a resource of the storage device is effectively used, and a storage device including a nonvolatile memory and a memory controller that have improved operation performance and an operation method of the storage device are provided.

Although a few embodiments of the present general application have been shown and described, it will be appreciated by those skilled in the art that changes may be made in these embodiments without departing from the principles and spirit of the general application, the scope of which is defined in the appended claims and their equivalents. Therefore, the above-disclosed subject matter is to be considered illustrative, and not restrictive.

1. An operation method of a storage device including a nonvolatile memory and a memory controller configured to control the nonvolatile memory, the method comprising:
receiving quality of service (QoS) information of a plurality of virtual channels;
storing the QoS information; and
accessing the nonvolatile memory using different schemes according to the stored QoS information and commands being received from the virtual channels, wherein
the plurality of virtual channels are channels through which the storage device communicates with an external device.

2. The operation method of claim 1, wherein:
the memory controller comprises a plurality of register sets corresponding to the plurality of virtual channels respectively,
the memory controller is configured to communicate with the external device through one input/output channel, and
each register set forms one virtual channel together with the one input/output channel.

3. The operation method of claim 2, wherein the accessing the nonvolatile memory using different schemes comprises:
distinguishing which virtual channel, among the plurality of virtual channels, a command is received through depending on which register set, among the register sets, the command is received through;
selecting an access scheme according to the distinguished virtual channel and a QoS corresponding to the distinguished virtual channel, the QoS being obtained from the QoS information; and
accessing the nonvolatile memory according to the selected access scheme.

4. The operation method of claim 1, wherein:
addresses of the nonvolatile memory are divided to be assigned to the plurality of virtual channels respectively, and
the accessing the nonvolatile memory using different schemes comprises:
distinguishing which virtual channel, among the virtual channels, a command is received through according to an address being received from the external device together with the command, the address corresponding to one of the plurality of virtual channels;
selecting an access scheme according to the distinguished virtual channel and a QoS corresponding to the distinguished virtual channel, the QoS being obtained from the QoS information; and
accessing the nonvolatile memory according to the selected access scheme.

5. The operation method of claim 1, wherein the accessing the nonvolatile memory using different schemes comprises:
performing a write operation of a first scheme with respect to the nonvolatile memory according to a first write command from a first virtual channel where a first QoS is required; and
performing a write operation of a second scheme with respect to the nonvolatile memory according to a second write command from a second virtual channel where a second QoS lower than the first QoS is required.

6. The operation method of claim 5, wherein a write speed of the first scheme is faster than a write speed of the second scheme.

7. The operation method of claim 5, wherein a degree that the nonvolatile memory is deteriorated according to the write operation of the second scheme is smaller than a degree that the nonvolatile memory is deteriorated according to the write operation of the first scheme.

8. The operation method of claim 1, wherein:
the storage device further comprises a buffer memory configured to store data to be written in the nonvolatile memory and data being read from the nonvolatile memory, and
the accessing the nonvolatile memory using different schemes comprises:
dividing a storage space of the buffer memory to assign the divided storage spaces to the plurality virtual channels respectively according to the QoS information; and
accessing the nonvolatile memory according to the commands using the storage spaces assigned to the plurality virtual channels respectively.

9. The operation method of claim 1, wherein:
the memory controller is configured to manage a command queue configured to store the commands,
the accessing the nonvolatile memory using different schemes comprises dividing slots of the command queue to generate a plurality of virtual command queues corresponding to the virtual channels respectively, and
queue depths of the plurality of virtual command queues are controlled according to the QoS information.

10. The operation method of claim 1, wherein:
the memory controller is configured to manage a command queue configured to store the commands,
the accessing the nonvolatile memory using different schemes comprises dividing slots of the command queue to generate a plurality of virtual command queues corresponding to the virtual channels respectively, and
the frequency that each of the command queues is selected and thereby a command is performed is controlled according to the QoS information.

11. The operation method of claim 1, wherein:
the memory controller is configured to manage a command queue configured to store the commands, and
the accessing the nonvolatile memory using different schemes comprises:
enqueuing the commands in the command queue; and
scheduling the commands enqueued in the command queue according to the QoS information.

12. The operation method of claim 11, wherein
a maximum delay time that the commands enqueued in the command queue are delayed by the scheduling is differently set according to the QoS information.

13. The operation method of claim 1, wherein:
the memory controller is configured to manage a command queue configured to store the commands, and
the accessing the nonvolatile memory using different schemes comprises:
selecting activation channels among the channels according to the QoS information; and
accessing the nonvolatile memory using the selected activation channels.

14. The operation method of claim 1, wherein:
the memory controller is configured to manage a command queue configured to store the commands, and
the accessing the nonvolatile memory using different schemes comprises:
selecting a first command from the command queue; and
performing the first command according to a second QoS in the case that the second QoS of a second command subsequent to the first command is higher than a first QoS of the first command, and performing the first command according to the first QoS in the case that the second QoS is not higher than the first QoS.

15. (canceled)

16. A method of accessing a nonvolatile memory executed by a memory controller, the method comprising:
receiving quality of service (QoS) information and a command corresponding to each of a plurality of virtual machines;
allocating a resource for supporting each virtual machine in accordance with the corresponding QoS information; and
accessing, with each of the virtual machines, the nonvolatile memory according to the corresponding command and using the allocated resource.

17. The method of claim 16, wherein the allocated resource is a speed that data is written to the nonvolatile memory.

18. The method of claim 16, wherein the allocated resource is a scheduling priority for accessing the nonvolatile memory.

19. The method of claim 16, wherein the allocated resource is random access memory assigned to each of the virtual machines.

20. The method of claim 16, wherein the allocated resource is one or more communication channels between the memory controller and the nonvolatile memory.

21-24. (canceled)

25. An operating method of a storage device including a nonvolatile memory and a memory controller, the operating method comprising:
detecting reception of a command at one register of a plurality of registers, the plurality of registers having quality of service (QoS) information respectively;
selecting an access according to the command and a QoS information assigned to one register; and
accessing the nonvolatile memory according to the selected access scheme.
